(19) United States
(12) Patent Application Publication
(10) Pub. No.: US 2026/0201128 A1
(43) Pub. Date: Jul. 16, 2026

(54) MICROWAVE-ASSISTED SYNTHESIS OF POLYACRYLIC BEADS AND THE USE THEREOF

(71) Applicant: Temple University - Of The Commonwealth System of Higher Education, Philadelphia, PA (US)

(72) Inventors: Rouzbeh Afsarmanesh Tehrani, Emeryville, CA (US); Farbod Alimohammadi, Philadelphia, PA (US)

(21) Appl. No.: 19/133,780

(22) PCT Filed: Jan. 9, 2024
(86) PCT No.: PCT/US2024/010821

§ 371 Date: May 29, 2025

Related U.S. Application Data
(60) Provisional application No. 63/479,294, filed on Jan. 10, 2023.

(51) Int. Cl. C08J 5/02; C08K 3/16; C08L 33/02

(52) U.S. Cl. CPC C08J 5/02; C08K 3/16; C08L 33/02

(57) ABSTRACT

A novel method of synthesizing polyacrylic beads, comprising the steps of suspending a monomer and a cross-linking agent in a solution, heating the solution in a microwave reactor, cooling the solution, and collecting the polyacrylic beads. The polyacrylic beads can be used in to remove solutes from various solutions, including blood, porcine blood, dialysate, serum, contaminated water, wastewater, and combinations thereof.

### CROSS-REFERENCE TO RELATED APPLICATIONS

This application claims priority to and the benefit of U.S. Provisional Application No. 63/479,294, filed Jan. 10, 2023, the disclosure of which is incorporated herein by reference herewith in its entirety.

### BACKGROUND OF THE INVENTION

Kidney failure is the 9th leading cause of death in the US with an estimated 1 in 7 (37 million) US adults suffering from progressive chronic kidney disease (CKD) (Chronic Kidney Disease in the United States, 2021, Chronic Kidney Disease Initiative). Early stages of CKD can progress to end-stage kidney disease (ESKD), a severe loss of kidney function, or kidney failure that affects 786,000 people in the US (Kidney Disease Statistics for the United States, 2022, National Institute of Diabetes and Digestive and Kidney Diseases). CKD and ESKD are significant economic burdens on the US health care system. The Medicare program spends $130 billion—more than 24% of total spending—on patients with kidney disease annually (Legislative Priorities: Federal Investment, 2022, National Kidney Foundation). Patients facing ESKD have limited options and must either receive a kidney transplant or undergo regular dialysis treatments, hemodialysis being the most common (End Stage Renal Disease, 2022). Hemodialysis involves lengthy and frequent treatments that tether patients to hemodialysis machines and erode their quality of life (Agarwal et al., 2015, American Journal of Nephrology, 41, 400-408). As a result, missed or shortened hemodialysis treatments are common among patients (Nicholas et al., 2015, Adv. Chronic Kidney Dis., 22, 6-15; Obialo et al., 2014, Journal of Nephrology, 27, 425-430).

If left untreated, ESKD leads to an accumulation of uremic toxins within the blood that interferes with the body's homeostasis. As a result, patients have an increased risk of early death and suffer from life-threatening conditions such as heart disease, stroke, anemia, excess fluids in the body, a weakened immune system, and depression (CKD Related Health Problems, 2022). Patients facing ESKD have limited options and must either receive a kidney transplant or undergo regular hemodialysis treatments. Almost 100,000 ESKD patients waited to receive a kidney in 2021, and the need is continuously expanding as 3,000 new patients are added to the list monthly. Unfortunately, a consistent shortage of eligible donors resulted in only 27% of patients on the waitlist receiving kidney transplants in 2021 (Organ Donation and Transplantation Statistics, 2022; Organ Donation Statistics, 2022). The global COVID-19 pandemic has exacerbated the need for hemodialysis, and 15-20% of hospitalized patients are being discharged with acute kidney injury (AKI), which forecasts a future increase in the number of ESKD patients (Kidney disease & COVID-19, National Kidney Foundation, 2020). Because of the scarcity of donor kidneys, 71% of ESKD patients received hemodialysis in 2021. Hemodialysis involves lengthy and frequent treatments (4 hrs, 3× per week) that tether patients to hemodialysis machines and erode their quality of life. As a result, up to 50% of patients leave treatments early and up to 30% skip sessions altogether. After a few days of skipping hemodialysis, patients are rushed to emergency rooms and are often hospitalized or admitted to an intensive care unit, costing Medicare thousands of dollars per patient's nonadherence. Hemodialysis care costs Medicare over $36 billion annually. The current hemodialysis treatment barely provides 10-15% of the clearance of healthy kidneys, and technical advances for kidney replacement therapies have been minimal over the past several decades.

The pathology of hemodialysis patients is complex and involves inadequate removal of toxins and waste (Meyer & Hostetter, New England Journal of Medicine, 2007, 357, 1316-1325), hemodialysis-induced oxidative stress (Túri et al., Free Radical Biology & Medicine, 1997, 22, 161-168), and inflammation due to the membranes used in hemodialysis (Herbelin et al., Kidney International, 1990, 37, 116-125). Therefore, most technical advancements in hemodialysis have primarily focused on creating biocompatible antioxidant dialyzer membranes (Neelakandan et al., Biomacromolecules, 2011, 12, 2447-2455; Senthilkumar et al., Materials Science and Engineering, 2013, 33, 3615-3626) and modifying the dialysates (Himmelfarb & Ikizler, 2010, New England Journal of Medicine, 2010, 363, 1833-1845). Integrating functionalized nanoparticles, polymeric beads, and composites in micro- and nanoscale into the dialysate presents a promising approach to enhance the efficacy and reduce the adverse effects of hemodialysis. Several companies are developing hemodialysis technologies to improve patient autonomy and quality of life, such as wearable kidney devices. However, the existing technological advancements for hemodialysis treatment are not designed to improve hemodialysis efficiency or reduce time spent in hemodialysis.

Thus, there is a need in the art for methods and innovations in hemodialysis treatments that can improve patient compliance and hemodialysis outcomes. Previous studies have reported that hemodialysis efficacy can be improved by incorporating adsorptive materials into the dialysate solution that increase toxin removal. Thus, the identification of suspended nanoparticles, micro- and nanoscale polymeric beads and composites that can be added to the dialysate and can improve toxin clearance and increase hemodialysis efficiency is an innovative solution to an unmet need in hemodialysis.

### SUMMARY OF THE INVENTION

The present invention is drawn to, in part, a method of synthesizing polyacrylic beads, comprising the steps of: suspending a monomer and a cross-linking agent in a solution; heating the solution in a microwave reactor; cooling the solution; and collecting the polyacrylic beads.

In one embodiment, the solution further comprises at least one additional component selected from the group consisting of hydroxyethyl cellulose, sodium chloride, and polyethylene glycol.

In one embodiment, the monomer is selected from the group consisting of methacrylic acid, dimethylaminomethyl methacrylate, butyl acrylate, ethyl acrylate, 2-hydroxyethyl methacrylate, vinyl acetate, 2-acrylamido-2-methylpropanesulfonic acid, vinylsulfonic acid, styrenesulfonic acid, 2-(dimethylamino)ethyl methacrylate, 2-(methacryloyloxy)ethyltrimethylammonium chloride, vinylphosphonic acid, 2-methacryloyloxyethylphosphonic acid, 2-hydroxyethyl methacrylate, vinyl pyrrolidone, ethylene glycol methacrylate, 2-methacryloyloxyethyl phosphorylcholine, allyl methacrylate, acrylic acid, methyl methacrylate, acrylate, glycidyl methacrylate, methacrylate derivatives of heparin, polyurethane with phosphorylcholine groups, silicone monomers, and combinations thereof.

In one embodiment, the cross-linking agent is selected from the group consisting of divinylbenzene, 2,2-bis(allyloxymethyl)-1-butanol, triallylamine, 7-octadiyne, 5-hexynoic acid, trimethylolpropane diallyl ether, diallyl ether, and 1,3,5-triallyl-1,3,5-triazine-2,4,6(1H,3H,5H)-trione, ethylene glycol dimethacrylate, 1,4-butanediol dimethacrylate, tetraethylene glycol dimethacrylate, N,N′-methylenebis(acrylamide), 1,3-dioxolane-2,4-dione, N,N′-divinylurea, 1,7-octadiyne, hexamethylene diisocyanate, diallyl phthalate, cyanuric chloride, trimethylolpropane trimethacrylate and combinations thereof.

In one embodiment, the reaction initiator is selected from the group consisting of benzoyl peroxide, azobisisobutyronitrile, and potassium persulfate and combinations thereof.

In one embodiment, the solution is heated in a microwave reactor for about 10 minutes. In one embodiment, the solution is heated in a microwave reactor for about 30 minutes. In one embodiment, the solution is heated in a microwave reactor for about 60 minutes.

In one embodiment, the method further comprises the step of adding the polyacrylic beads to a sodium hydroxide solution to synthesize sodium polyacrylic beads.

In one embodiment, the sodium hydroxide solution has a concentration of about 0.1 M to about 0.2 M.

The present invention is further drawn to polyacrylic beads synthesized using the method of the present invention. In one embodiment, the polyacrylic beads are hyperelastic. In one embodiment, the polyacrylic beads have an alpha value of about 5 to about 11 in the Ogden model. In one embodiment, the polyacrylic beads have a mu value of about 0.01 to about 10.0 in the Ogden model.

The present invention is also drawn to a method of removing solutes from a solution comprising the steps of: providing the polyacrylic beads of the present invention; and suspending the beads in a solution comprising at least one solute.

In one embodiment, the solution is selected from the group consisting of blood, porcine blood, dialysate, serum, contaminated water, and combinations thereof. In one embodiment, solutes are selected from the group consisting of creatinine, sodium cation, potassium cation, calcium cation, and combinations thereof.

In one embodiment, the polyacrylic beads are about 50 nm to about 100 nm in size. In one embodiment, the polyacrylic beads are about 50 to about 100 μm in size.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1, comprising FIG. 1A through FIG. 1C, depicts cation uptake. FIG. 1A depicts calcium uptake of the PMA-Na in the dialysate solution. FIG. 1B depicts potassium uptake of the PMA-Na in the dialysate solution. FIG. 1C depicts sodium uptake of the PMA-Na in the dialysate solution.

FIG. 2 depicts the schematic preparation of poly(methacrylic) acid beads by microwave radiation.

FIG. 3, comprising FIG. 3A through FIG. 3D, depicts scanning electron microscopy (SEM) images of particles with different ratios of cross-linker to monomer. FIG. 3A depicts PMAA-3. FIG. 3B depicts PMAA-8. FIG. 3C depicts PMAA-16. FIG. 3D depicts PMAA-25.

FIG. 4, comprising FIG. 4A through FIG. 4D, depicts fluorescence images of particles with different ratios of cross-linker to monomer. FIG. 4A depicts PMAA-3. FIG. 4B depicts PMAA-8. FIG. 4C depicts PMAA-16. FIG. 4D depicts PMAA-25 (magnification of the 10×).

FIG. 5 depicts SEM images of particles synthesized with acetonitrile solvent with divinylbenzene as crosslinkers.

FIG. 6 depicts the ion exchange reaction to replace hydrogen with sodium ion.

FIG. 7 depicts experimental creatinine adsorption kinetics of poly(methacrylic) acid beads (8.3% crosslinker), creatinine removal in dialysate solution.

FIG. 8, comprising FIG. 8A through FIG. 8C, depicts experimental adsorption kinetics of poly(methacrylic) acid beads (16% crosslinker). FIG. 8A depicts dialysate solution. FIG. 8B depicts porcine blood. FIG. 8C depicts sodium poly(methacrylic) beads in porcine blood.

FIG. 9, comprising FIG. 9A and FIG. 9B, depicts optical microscopic images of red blood cells sampled from the suspensions. FIG. 9A depicts incubated porcine blood incubated with the poly(methacrylic) acid microbeads. FIG. 9B depicts the porcine blood incubated with the poly(methacrylic) acid microbeads (Magnification 60×).

FIG. 10, comprising FIG. 10A through FIG. 10F, depicts PMAA characterization data. FIG. 10A depicts X-ray diffraction patterns. FIG. 10B depicts crystallinity percentages of the samples and crystallite size. FIG. 10C depicts Brunauer-Emmett-Teller (BET). FIG. 10D depicts FTIR of the PMAA particles. FIG. 10E depicts thermal gravimetric analysis (TGA) data of PMAA particles. FIG. 10F depicts differential scanning calorimetry data of PMAA particles.

FIG. 11, comprising FIG. 11A through FIG. 11D, depicts photographs of different PMAA samples after the compressive strength test. FIG. 11A depicts PMAA-3. FIG. 11B depicts PMAA-8. FIG. 11C depicts PMAA-16. FIG. 11D depicts PMAA-25.

FIG. 12, comprising FIG. 12A and FIG. 12B, depicts additional characterization data of PMAA particles. FIG. 12A depicts a graph of nominal strain versus stress derived from in-situ microtesting of PMAA particles with the Ogden model fits. FIG. 12B depicts deformation resistance of the PMAA particles.

FIG. 13, comprising FIG. 13A through FIG. 13D, depicts dialysate data. FIG. 13A depicts sodium uptake. FIG. 13B depicts potassium uptake. FIG. 13C depicts calcium uptake of the PMAA in the dialysate solution. FIG. 13D depicts pH of the dialysate solution after 4 h treatment.

FIG. 14, comprising FIG. 14A and FIG. 14B, depicts blood compatibility data. FIG. 14A depicts calcium uptake in the porcine blood. FIG. 14B depicts pH after 4 h treatment. The pH of the PMAA-3 and pH-8 was not detectable by i-stat.

FIG. 15, comprising FIG. 15A and FIG. 15B, depicts hemoperfusion data. FIG. 15A depicts the hemoperfusion test setup. FIG. 15B depicts the calcium concentration, pH and blood hemolysis after each blood pass through the syringe.

FIG. 16, comprising FIG. 16A through FIG. 16F, depicts evaluation of blood compatibility upon contact with PMAA-16. FIG. 16A depicts a representative assay in Bovine Serum Albumin (BSA). FIG. 16B depicts a representative assay in complement component 3a (C3a). FIG. 16C depicts a representative assay in Platelet Factor 4 (PF4). FIG. 16D depicts a representative assay in Thrombin-Antithrombin complex (TAT). FIG. 16E depicts light microscopy images of untreated blood. FIG. 16F depicts blood after exposure to PMAA-16, both visualized at 40× magnification.

FIG. 17 depicts an approach to manage potassium removal during hemodialysis aimed to minimize cardiac events. In this approach, the potassium concentration gradient between blood and dialysate is maintained at 1 [mmol/l] throughout the treatment. The dotted lines represent theoretical concentration of potassium in blood and dialysate aiming to maintain a constant and minimal concentration gradient. The red and orange lines represent the experimental data collected using polymeric beads for potassium management during hemodialysis.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

### Methods of Making

In one aspect, the present invention relates to a method of synthesizing crosslinked polymer beads by suspending one or more monomers with a cross-linking agent in a solution, heating the solution using microwave irradiation, cooling the heated solution, and collecting the product.

In one embodiment, the solution comprises hydroxyethyl cellulose. In one embodiment, the solution comprises sodium chloride. In one embodiment, the solution comprises polyethylene glycol. In one embodiment, the solution comprises calcium chloride. In one embodiment, the solution comprises polyvinylpyrrolidone.

In one embodiment, the solution is aqueous. In one embodiment, the solution comprises a polar solvent. In one embodiment, the solution is a combination of an aqueous and polar solvent. Exemplary polar solvents include, but are not limited to, alcohols, acetone, ethyl acetate, dimethylsulfoxide, dimethylformamide, tetrahydrofuran, acetonitrile, crown ethers, n-octane, toluent, and N-methyl pyrrolidine.

In one embodiment, the initiator is benzoyl peroxide. In one embodiment, the initiator is azobisisobutyronitrile. In one embodiment, the initiator is ammonium persulfate. In one embodiment, the initiator is potassium persulfate.

In one embodiment, the monomer is acrylic acid. In one embodiment, the monomer is methacrylic acid. In one embodiment, the monomer is methyl methacrylate. In one embodiment, the monomer is acrylate. In one embodiment, the monomer is dimethylaminomethyl methacrylate. In one embodiment, the monomer is butyl acrylate. In one embodiment, the monomer is ethyl acrylate. In one embodiment, the monomer is 2-hydroxyethyl methacrylate. In one embodiment, the monomer is vinyl acetate. In one embodiment, the monomer is 2-acrylamido-2-methylpropanesulfonic acid. In one embodiment, the monomer is vinylsulfonic acid. In one embodiment, the monomer is styrenesulfonic acid. In one embodiment, the monomer is 2-(dimethylamino)ethyl methacrylate. In one embodiment, the monomer is 2-(methacryloyloxy)ethyltrimethylammonium chloride. In one embodiment, the monomer is vinylphosphonic acid. In one embodiment, the monomer is 2-methacryloyloxyethylphosphonic acid. In one embodiment, the monomer is 2-hydroxyethyl methacrylate. In one embodiment, the monomer is vinyl pyrrolidone. In one embodiment, the monomer is ethylene glycol methacrylate. In one embodiment, the monomer is 2-methacryloyloxyethyl phosphorylcholine. In one embodiment, the monomer is allyl methacrylateglycidyl methacrylate. In one embodiment, the monomer is ethylene bismethacrylate. In one embodiment, the monomer is methacrylate derivatives of heparin. In one embodiment, the monomer is polyurethane with phosphorylcholine groups. In one embodiment, the monomer is a silicone monomer. Any embodiment involving an acrylate is applicable to any embodiment involving a methacrylate or combination of the monomers, and vice-versa.

In one embodiment, the cross-linking agent is a bis-alkene. In one embodiment, the cross-linking agent is divinylbenzene. In one embodiment, the cross-linking agent is 2,2-bis(allyloxymethyl)-1-butanol. In one embodiment, the cross-linking agent is triallylamine. In one embodiment, the cross-linking agent is 7-octadiyne. In one embodiment, the cross-linking agent is 5-hexynoic acid. In one embodiment, the cross-linking agent is trimethylolpropane diallyl ether. In one embodiment, the cross-linking agent is diallyl ether. In one embodiment, the cross-linking agent is 1,3,5-triallyl-1,3,5-triazine-2,4,6(1H,3H,5H)-trione. In one embodiment, the cross-linking agent is methylenebis(acrylamide). In one embodiment, the cross-linking agent is ethylene glycol dimethyacrylate. In one embodiment, the cross-linking agent is 1,4-butanediol dimethacrylate. In one embodiment, the cross-linking agent is tetraethylene glycol dimethacrylate. In one embodiment, the cross-linking agent is N,N′-methylenebis(acrylamide). In one embodiment, the cross-linking agent is 1,3-dioxolane-2,4-dione. In one embodiment, the cross-linking agent is N,N′-divinylurea. In one embodiment, the cross-linking agent is 1,7-octadiyne. In one embodiment, the cross-linking agent is hexamethylene diisocyanate. In one embodiment, the cross-linking agent is diallyl phthalate. In one embodiment, the cross-linking agent is cyanuric chloride. In one embodiment, the cross-linking agent is trimethylolpropane trimethacrylate.

In one embodiment, the solution comprises a plasticizing agent. In one embodiment, the plasticizing agent is an adipate. In one embodiment, the plasticizing agent is a benzoate. In one embodiment, the plasticizing agent is a citrate. In one embodiment, the plasticizing agent is a phosphate. In one embodiment, the plasticizing agent is a phthalate. In one embodiment, the plasticizing agent is a trimetallate ester.

In one embodiment, the solution is heated using microwave irradiation to about 40° C. In one embodiment, the solution is heated using microwave irradiation to about 45° C. In one embodiment, the solution is heated using microwave irradiation to about 50° C. In one embodiment, the solution is heated using microwave irradiation to about 55° C. In one embodiment, the solution is heated using microwave irradiation to about 60° C. In one embodiment, the solution is heated using microwave irradiation to about 65° C. In one embodiment, the solution is heated using microwave irradiation to about 70° C. In one embodiment, the solution is heated using microwave irradiation to about 75° C. In one embodiment, the solution is heated using microwave irradiation to about 80° C. In one embodiment, the solution is heated using microwave irradiation to about 85° C. In one embodiment, the solution is heated using microwave irradiation to about 90° C. In one embodiment, the solution is heated using microwave irradiation to about 100° C. In one embodiment, the solution is heated using microwave irradiation to about 110° C. In one embodiment, the solution is heated using microwave irradiation to about 120° C. In one embodiment, the solution is heated using microwave irradiation to about 130° C. In one embodiment, the solution is heated using microwave irradiation to about 140° C.

In one embodiment, the solution is heated using microwave irradiation for about 5 minutes. In one embodiment, the solution is heated using microwave irradiation for about 10 minutes. In one embodiment, the solution is heated using microwave irradiation for about 15 minutes. In one embodiment, the solution is heated using microwave irradiation for about 20 minutes. In one embodiment, the solution is heated using microwave irradiation for about 25 minutes. In one embodiment, the solution is heated using microwave irradiation for about 30 minutes. In one embodiment, the solution is heated using microwave irradiation for about 35 minutes. In one embodiment, the solution is heated using microwave irradiation for about 40 minutes. In one embodiment, the solution is heated using microwave irradiation for about 45 minutes. In one embodiment, the solution is heated using microwave irradiation for about 50 minutes. In one embodiment, the solution is heated using microwave irradiation for about 55 minutes. In one embodiment, the solution is heated using microwave irradiation for about 60 minutes. In one embodiment, the solution is heated using microwave irradiation for about 120 minutes. In one embodiment, the solution is heated using microwave irradiation for about 180 minutes.

In one embodiment, the products are polymeric beads. In one embodiment, the products are composites. In one embodiment, the products are microscale in diameter. In one embodiment, the products are nanoscale in diameter. In one embodiment, the products are microscale and nanoscale in diameter.

In one embodiment, the polymeric beads are added to dialysate solution as suspended particles. In one embodiment, the composites are added to dialysate solution as suspended particles. In one embodiment, polymeric beads and composites are added to dialysate solution as suspended particles. In one embodiment, the particles remain stationary in the dialyzer after running the dialysate through the dialyzer. In one embodiment, the particles flow through the system. In one approach the dialysate solution with the polymeric beads is recirculated and reused during one dialysis treatment.

Any embodiment drawn to poly(methacrylic acid) beads throughout the present disclosure is applicable to any embodiment drawn to polyacrylic beads and polymeric beads, and vice versa. In one embodiment, the polymeric beads that are added have a wide range of sizes or diameters. In one embodiment, the polymeric beads are synthesized in a wide range of sizes. In one embodiment, the size of the poly(methacrylic acid) beads is about 50 nm to about 60 nm. In one embodiment, the size of the poly(methacrylic acid) beads is about 60 nm to about 70 nm. In one embodiment, the size of the poly(methacrylic acid) beads is about 70 nm to about 80 nm. In one embodiment, the size of the poly(methacrylic acid) beads is about 80 nm to about 90 nm. In one embodiment, the size of the poly(methacrylic acid) beads is about 90 nm to about 100 nm. In one embodiment, the size of the poly(methacrylic acid) beads is about 100 nm to about 200 nm. In one embodiment, the size of the poly(methacrylic acid) beads is about 200 nm to about 300 nm. In one embodiment, the size of the poly(methacrylic acid) beads is about 300 nm to about 400 nm. In one embodiment, the size of the poly(methacrylic acid) beads is about 400 nm to about 500 nm. In one embodiment, the size of the poly(methacrylic acid) beads is about 500 nm to about 600 nm. In one embodiment, the size of the poly(methacrylic acid) beads is about 600 nm to about 700 nm. In one embodiment, the size of the poly(methacrylic acid) beads is about 700 nm to about 800 nm. In one embodiment, the size of the poly(methacrylic acid) beads is about 800 nm to about 900 nm. In one embodiment, the size of the poly(methacrylic acid) beads is about 900 nm to about 1000 nm.

In one embodiment, the size of the poly(methacrylic acid) beads is about 50 μm to about 60 μm. In one embodiment, the size of the poly(methacrylic acid) beads is about 60 μm to about 70 μm. In one embodiment, the size of the poly(methacrylic acid) beads is about 70 μm to about 80 μm. In one embodiment, the size of the poly(methacrylic acid) beads is about 80 μm to about 90 μm. In one embodiment, the size of the poly(methacrylic acid) beads is about 90 μm to about 100 μm. In one embodiment, the size of the poly(methacrylic acid) beads is about 100 μm to about 200 μm. In one embodiment, the size of the poly(methacrylic acid) beads is about 200 μm to about 300 μm. In one embodiment, the size of the poly(methacrylic acid) beads is about 300 μm to about 400 μm. In one embodiment, the size of the poly(methacrylic acid) beads is about 400 μm to about 500 μm. In one embodiment, the size of the poly(methacrylic acid) beads is about 500 μm to about 600 μm. In one embodiment, the size of the poly(methacrylic acid) beads is about 600 μm to about 700 μm. In one embodiment, the size of the poly(methacrylic acid) beads is about 700 μm to about 800 μm. In one embodiment, the size of the poly(methacrylic acid) beads is about 800 μm to about 900 μm. In one embodiment, the size of the poly(methacrylic acid) beads is about 900 μm to about 1000 μm.

In one embodiment, the polyacrylic beads are hyperelastic.

In one embodiment, the polyacrylic beads have an alpha (α) value of about 5 to about 15 in the Ogden model. In one embodiment, the polyacrylic beads have an a value of about 5 to about 14. In one embodiment, the polyacrylic beads have an a value of about 5 to about 13. In one embodiment, the polyacrylic beads have an a value of about 5 to about 12. In one embodiment, the polyacrylic beads have an a value of about 5 to about 11. In one embodiment, the polyacrylic beads have an a value of about 5 to about 10.

In one embodiment, the polyacrylic beads have a mu (u) value of about 0.01 to about 10.0 in the Ogden model. In one embodiment, the polyacrylic beads have a μ value of about 0.01 to about 9.0. In one embodiment, the polyacrylic beads have a μ value of about 0.02 to about 10.0. In one embodiment, the polyacrylic beads have a μ value of about 0.03 to about 10.0. In one embodiment, the polyacrylic beads have a μ value of about 0.04 to about 10.0. In one embodiment, the polyacrylic beads have a μ value of about 0.05 to about 10.0. In one embodiment, the polyacrylic beads have a μ value of about 0.06 to about 10.0. In one embodiment, the polyacrylic beads have a μ value of about 0.06 to about 9.0.

In another aspect, the present method provides the synthesis of sodium poly(methacrylic) beads. In one embodiment, the method comprises the step of adding poly(methacrylic acid) beads to a sodium hydroxide solution, then washing with distilled water.

In one embodiment, the sodium hydroxide solution has a concentration of about 0.005 M to about 0.01 M. In one embodiment, the sodium hydroxide solution has a concentration of about 0.01 M to about 0.10 M. In one embodiment, the sodium hydroxide solution has a concentration of about 0.01 M to about 0.15 M. In one embodiment, the sodium hydroxide solution has a concentration of 0.01 M to about 0.20 M.

### Methods of Use

In another aspect, the present invention relates to a method of using the synthesized particles to remove solutes from a solution. Exemplary solutes include, but are not limited to, uremic toxins, protein-bound uremic toxins, such as indoxyl sulfate and p-cresyl sulfate, solutes which have high affinity for plasma proteins, albumin, middle molecules, such as beta-2 microglobulin, creatinine, and cations such as sodium cation, potassium cation, and calcium cation. In one embodiment, the particles used to remove solutes from the solution are polyacrylic beads. In one embodiment, the particles used to remove solutes from the solution are sodium poly(methacrylic) beads. In one embodiment, the particles used to remove solutions from the solution are composites. In one embodiment, the solutes are removed from porcine blood. In one embodiment, the solutes are removed from dialysate. In one embodiment, the solutes are removed from wastewater. In one embodiment, the solutes are removed during hemodialysis. In one embodiment, the solutions are removed through hemoperfusion.

In one embodiment, the particles are suspended in the solution. In one embodiment, the suspended particles are used as scaffolds to deliver functionalized organic and inorganic composites. In one embodiment, the suspended particles are used as scaffolds to deliver amorphous powders. In one embodiment, the suspended particles are used as scaffolds to deliver crystalline structures. In one embodiment, the particles are added for the removal of ions, small to large proteins, and enzymes. In one embodiment, the particles are added to slowly release enzymes, molecules, and electrolytes/ions. In one embodiment, the particles are used as scaffolds to deliver at least one FDA-approved active ingredient. In one embodiment, the particles are used as scaffolds to deliver at least one FDA-approved functional group. In one embodiment, the FDA-approved active ingredient comprises at least one potassium binder. Exemplary potassium binders include, but are not limited to, cation exchange polymers, inorganic materials, sodium zirconium cyclosilicate (Lokelma), patiromer, calcium polystyrene sulfonate, and sodium polystyrene sulfonate for potassium management. In one embodiment, the FDA-approved active ingredient or functional group comprises at least one phosphate binder. Exemplary phosphate binders include, but are not limited to, calcium acetate, sevelamer carbonate, sevelamer hydrochloride, aluminum hydroxide, calcium acetate/magnesium carbonate, calcium carbonate, colestilan, sucroferric oxyhydroxide, fermagate, ferric citrate and lanthanum salts, such as lanthanum carbonate, lanthanum fluoride, and lanthanum oxides, lanthanum hydroxide. Further exemplary binders include polymyxin b (Poly-Rx), deferoxamine (Desferal), edetate calcium disodium (Calcium Disodium Versenate), penicillamine (CUPRIMINE), dimercaptosuccinic acid (Chemet), rasburicase (Elitek), colestid (Colestipol), colesevelam (Welchol), and prevalite (Cholestyramine).

In one embodiment, the addition of the particles accelerates the removal rates. In one embodiment, the addition of the particles manages the removal rate of targeted ions and molecules by controlling the concentration gradients.

In one embodiment, the concentration gradient between blood and dialysate is decreased. In one embodiment, the concentration gradient between blood and dialysate is increased. In one embodiment, the concentration gradient is kept constant throughout the treatment. In one embodiment, the concentration gradient is dependent on the electrolytes or toxins of interest. In several embodiments, the addition of the composites manages the removal rates of solutes. In one embodiment, the added composites remain stationary in the dialyzer. In one embodiment, the particles retain the solutes. In one embodiment, polymeric beads and composites are used for high flux and medium cutoff dialyzers.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the compositions of the present invention and practice the claimed methods. The following working examples therefore, specifically point out various embodiments of the present invention, and are not to be construed as limiting in any way the remainder of the disclosure.

Poly(methacrylic acid) (PMAA) emerges as a material of notable significance across various industries, because of its distinctive properties, particularly its property in metal ion adsorption (Silva et al., 2018, Mineral Processing and Extractive Metallurgy Review, 39, 395; Howe, 1955, Journal of the Chemical Society; Vergili et al., 2016, Polymer Bulletin, 74, 2605). PMAA can attract and chelate metal ions, making it an attractive material for heavy metal removal from wastewater. The presence of carboxylic acid groups on PMAA particles represents its functionality, acting as weak acids facilitating ion exchange mechanisms where other metal ions can replace protons. The commercial availability of PMAA (Poly(methacrylic acid)) particles offers convenient access to these materials for various applications (Suteu et al., 2013, Journal of Applied Polymer Science, 131; Procopio, 2020, Drug Delivery Trends, 15). However, a critical limitation resides in the undisclosed nature of the industrial synthesis protocols used to manufacture these particles. The absence of this detailed methodological insight restricts the scientific community's understanding and control over the precise attributes of the resulting PMAA particles, such as their size, morphology, chemical composition, and overall performance in specific applications such as medical devices.

The initiation method utilized in polymerization processes profoundly influences the physical attributes of the resultant polymer, providing multiple avenues for radical initiation such as photo, thermal, and redox systems (Alimohammadi et al., 2016, Polymer, 105, 180; Shim et al., 2004, Macromolecular Research, 12, 233; Moulay, 2006, Journal of Applied Polymer Science, 100, 954; Kempe et al., 2011, Macromolecules, 44, 5825). Microwave-assisted polymerization has attracted substantial interest over recent decades due to its transformative impact on polymer properties and overall synthesis dynamics (Zong et al., 2003, J Microw Power Electromagn Energy, 38, 49; Wiesbrock et al., 2004, Macromolecular Rapid Communications, 25, 1739). This method is not only involved in modulating the polymer characteristics but also brings forth numerous advantages, including energy conservation, shortened reaction durations, enhanced yields, and control over the polymerization trajectory (Galina, 1979, Journal of Applied Polymer Science, 23, 3017; Galina, 1979, Journal of Applied Polymer Science, 24, 901; Hasirci, 1982, Journal of Applied Polymer Science, 27, 33; Galina, 1979, Journal of Applied Polymer Science, 24, 891).

Recently, there has been an increasing interest in developing specialized polymer particles for blood purification applications. Innovations in this field have led to synthesizing various polymers, each with unique functional groups that enhance blood purification processes (Jong et al., 2020, ACS Applied Polymer Materials, 2, 515; Zhou et al., 2019, ACS Biomater Sci Eng, 5, 3987; Dou et al., 2022, Materials Advances, 3, 918). Polyacrylic acid and phenylglyoxaldehyde-functionalized polymeric sorbents have emerged as key materials in these advancements, showing significant promise in blood purification methods.

Hyperkalemia and hypercalcemia are medical conditions characterized by abnormally elevated levels of potassium and calcium in the blood, exceeding 5 mEq/L and 14 mg/dL, respectively (Palmer et al., 2021, Mayo Clin Proc, 96, 744; Lee et al., 2006, Am J Med Sci, 331, 119). These electrolyte disorders pose a significant risk, potentially increasing mortality rates due to their tendency to induce lethal cardiac arrhythmias (Kes, 2001, Acta clin Croat, 40, 215; Guimaraes et al., 2017, Revista Portuguesa de Cardiologia (English Edition), 36, 959.e1; Akhtar et al., 2022, Eur Cardiol, 17, e05). Prompt diagnosis and effective management of these conditions are crucial to mitigate their adverse cardiac effects and improve patient outcomes. These conditions are particularly critical in patients with kidney disorders, for whom treatments such as hemoperfusion and hemodialysis are essential to regulate these cation concentrations effectively.

The kidneys act as a critical purifying organ, eliminating waste and excess fluids; however, their failure can lead to a critical imbalance of ions, causing various electrolyte disorders (Claure-Del Granado, 2012, Blood Purif, 34, 186; Levey, 2017, Ann Intern Med, 167, ITC66; Langstron, 2017, Vet Clin North Am Small Anim Pract, 47, 471). Several strategies have been introduced to address kidney functional deficiencies (Ma et al., 2021, Microporous and Mesoporous Materials, 319; Ameh et al., 2020, Int J Nephrol Renovasc Dis, 13, 239; Ramada et al., 2023, Nat Rev Nephrol, 19, 481; Himmelfarb, 2020, Nat Rev Nephrol, 16, 558). Hemodialysis, a conventional approach, facilitates the removal of waste products from the blood, leveraging the diffusion of ions driven by transmembrane pressure and ion concentration gradients.

Furthermore, innovations such as the wearable artificial kidney have been investigated as a new alternative for blood purification (Groth et al., 2023, Artif Organs, 47, 649; Fissell et al., 2013, Kidney Int, 84, 256). Despite being a promising solution, it is still in its preliminary developmental stages, and substantial costs limit its application. Hemoperfusion is another viable method for toxin removal, where blood is directly exposed to an absorbent, facilitating the removal of various toxins like cations, bilirubin, and creatinine (Davankov et al., 2000, J Chromatogr B Biomed Sci Appl, 739, 73). The challenge, however, lies in identifying an absorbent that is efficient in toxin removal and compatible with the blood, ensuring the safety and effectiveness of the purification process. This illustrates the continuous exploration and adaptation of methodologies to optimize solutions for kidney function disorders.

This study presents a novel approach to synthesizing poly(methacrylic acid) (PMAA) macroparticles, utilizing microwave irradiation as the reaction initiator-marking this as a pioneering method. This innovative methodology aimed at synthesizing particles with distinctive properties by manipulating various crosslinker concentrations. This is followed by exploring and analyzing the particles' physical and chemical characteristics, influenced by varying monomer ratios to crosslinker.

A central focus of the present study was to investigate the ion selectivity of the synthesized PMAA particles when interacting with dialysate or blood. The goal was to assess the efficiency and efficacy of the PMAA particles in removing cations, a critical aspect of their potential application in medical and health-related areas such as dialysis. Additionally, the compatibility of these particles with blood was a fundamental aspect of the inquiry, ensuring their applicability and safety in biological environments for processes like hemoperfusion in renal failure treatment strategies. This groundbreaking study paves the way for enhancing understanding and utilization of PMAA particles in medical science and healthcare technologies.

The present invention is drawn to a new method for the rapid synthesis of poly(methacrylic acid) (PMAA) macroparticles via microwave irradiation, optimizing the ratio of monomer to crosslinker to finely tailor the particles' characteristics. These particles have been characterized, and their possible effectiveness in blood purification applications has been investigated. They are demonstrating significant potential for cation removal from dialysate and blood. Blood compatibility assessments, encompassing protein adsorption and clotting time, showed the particles' hemocompatibility. The exceptional physical and mechanical attributes of the PMAA particles are positioned as promising candidates for use as absorbents in dialysis and hemoperfusion processes. Furthermore, their versatility extends beyond the precincts of blood purification, marking their relevance in broader applications such as water treatment.

The experimental materials and methods used herein will now be described.

### Materials

Divinyl Benzene (80%, technical grade), and methacrylic acid were purchased from Sigma Aldrich. Dibenzoyl peroxide was provided by Alfa-Aesar. Hydroxyethyl cellulose was purchased from Spectrum. Polyethylene glycol 20,000 was provided by Thermo Scientific Chemicals. Sodium Chloride Fisher BioReagents™. A Thermo Scientific™ Micro BCA™ Protein Assay Kit was utilized for protein quantification. For specific protein assays, the following kits were employed: Biotang Inc's Human Complement fragment 3a (C3a) ELISA Kit, Siemens Healthineers' Enzygnost™ TAT Micro Kit, and a Porcine Platelet Factor 4 ELISA Kit from Innovative Research.

### Polymethacrylic Acid (PMAA) Synthesis

A solution of methacrylic acid (0.3 mL), divinylbenzene (different volumes including 0.01, 0.025, 0.05 or 0.075 mL), and benzoyl peroxide (15 mg) was prepared and mixed, then added to 12 mL of the water phase (a solution contains hydroxyethyl cellulose (10 g/L), sodium chloride (350 g/L), and polyethylene glycol (50 g/L)). The prepared solution was added to a 30 mL reaction vial that was sealed with a septa cap and placed in a microwave reactor (Monowave 300, Anton Parr). The dispersion was gradually heated to 40° C. for 10 min, 60° C. for 10 min, 80° C. for 60 min, 90° C. for 30 min. The reaction dispersion was then quickly cooled to room temperature with pressurized airflow. The product was collected using the vacuum filter and washed with ethanol and DI water. The four different ratios of the DVB/MAA, including 3.3, 8.3, 16.6, and 25% (V/V), were used, called PMAA-3, PMAA-8, PMAA-16, and PMAA-25, respectively.

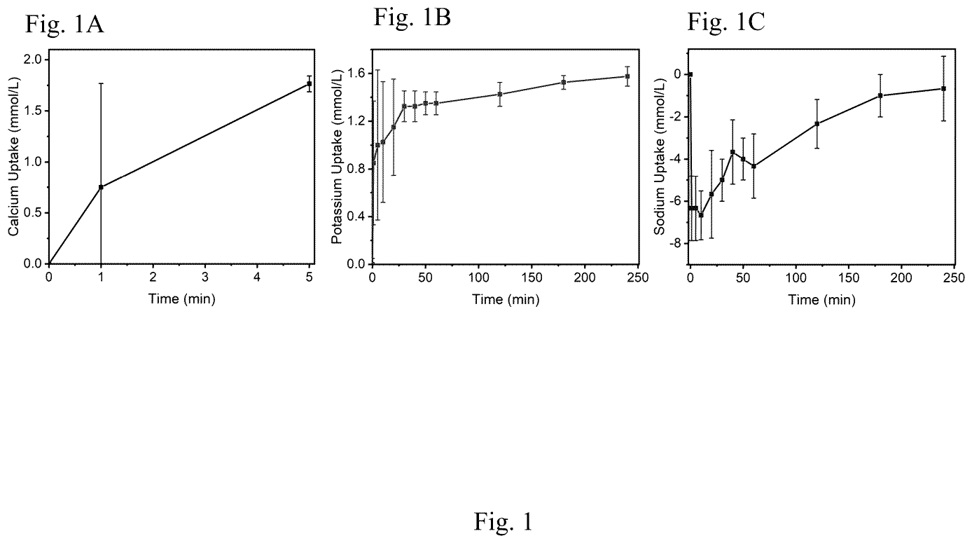

Sodium poly(methacrylic) (PMA-Na) was prepared by the addition of the poly(methacrylic) acid beads (PMAA-16) to 0.1M sodium hydroxide for 1 h, and then was washed with DI-water (FIG. 1).

Alternatively, a solution of methacrylic acid (0.3 mL), divinylbenzene (3-25% of monomer), and benzoyl peroxide (15 mg) were prepared and then added to 12 mL of a solution of hydroxyethyl cellulose, sodium chloride, and polyethylene glycol in water. Dicyclohexyl phthalate can be used as a plasticizer to modify the chemical and physical properties of the beads.

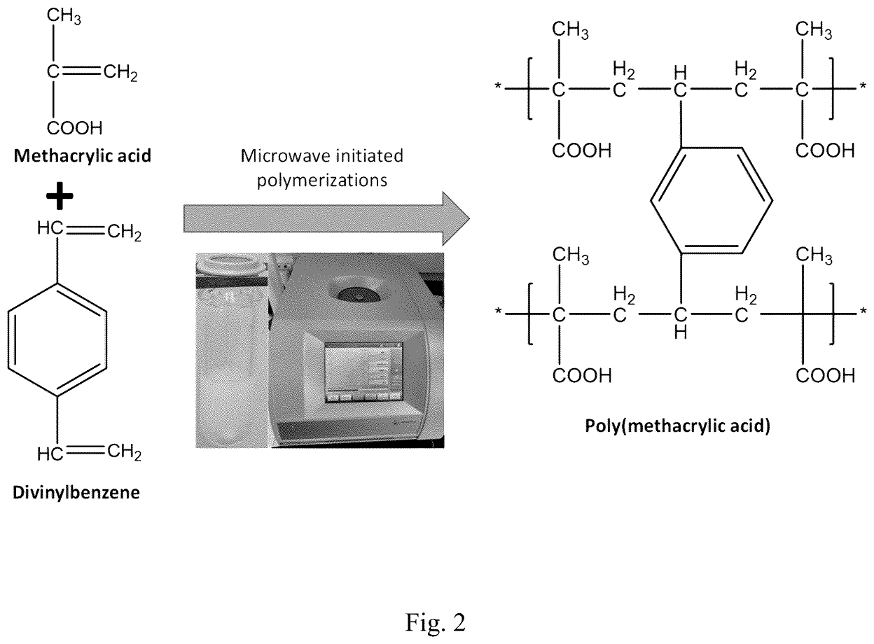

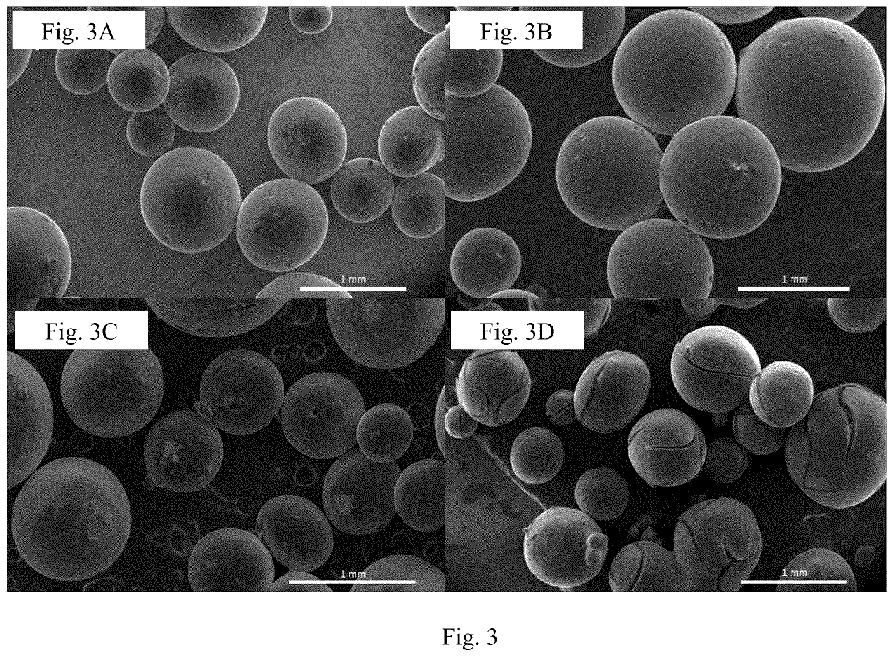

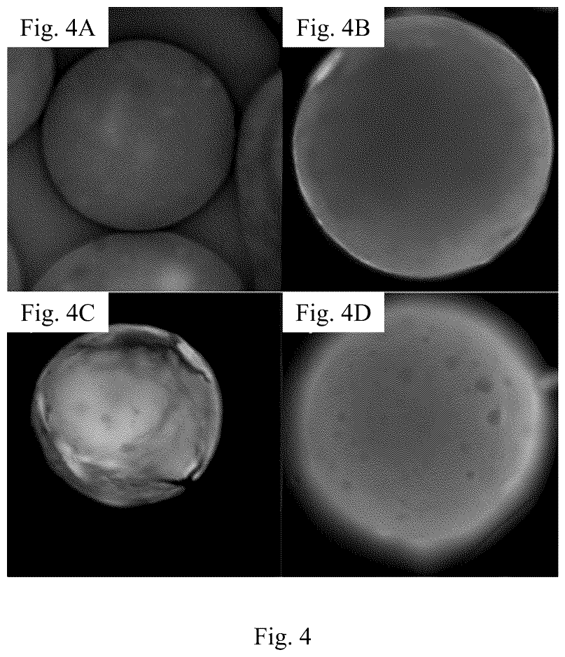

The prepared solution was added to a 30 mL reaction vial that was sealed with a septa cap and placed in a microwave reactor (Monowave 300, Anton Parr). The dispersion was gradually heated to 40° C. for 10 min, 60° C. for 10 min, 80° C. for 60 min, 90° C. for 30 min. The reaction dispersion was then quickly cooled down to room temperature with pressurized airflow (FIG. 2). The product was collected using the vacuum filter and washed with ethanol and DI water. The SEM and Fluorescence images of the final products are presented in FIG. 3 and FIG. 4.

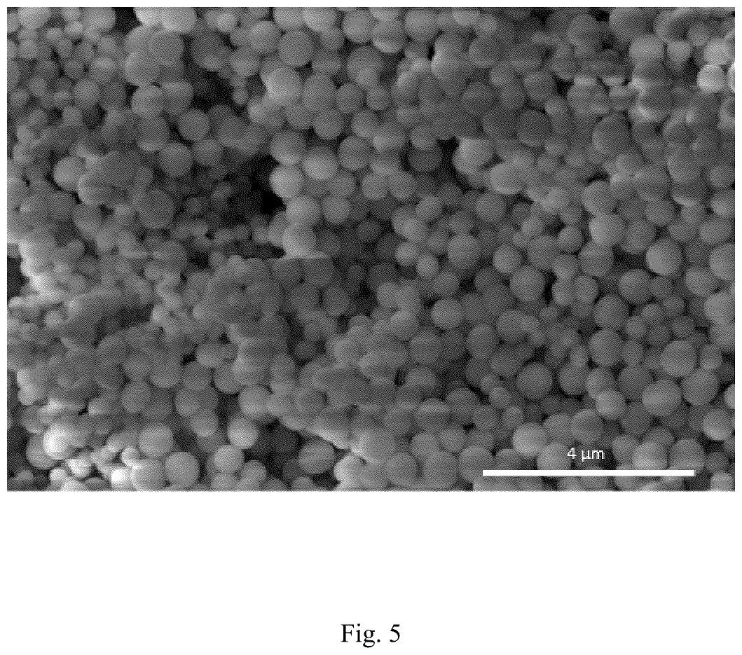

In an alternative approach, a solution of methacrylic acid (0.3 ml), divinylbenzene (16% of monomer), and benzoyl peroxide (15 mg) were mixed and then added to 10 ml of a solution of the acetonitrile and surfactant (Tween 80). The SEM image of the final product is presented in FIG. 5.

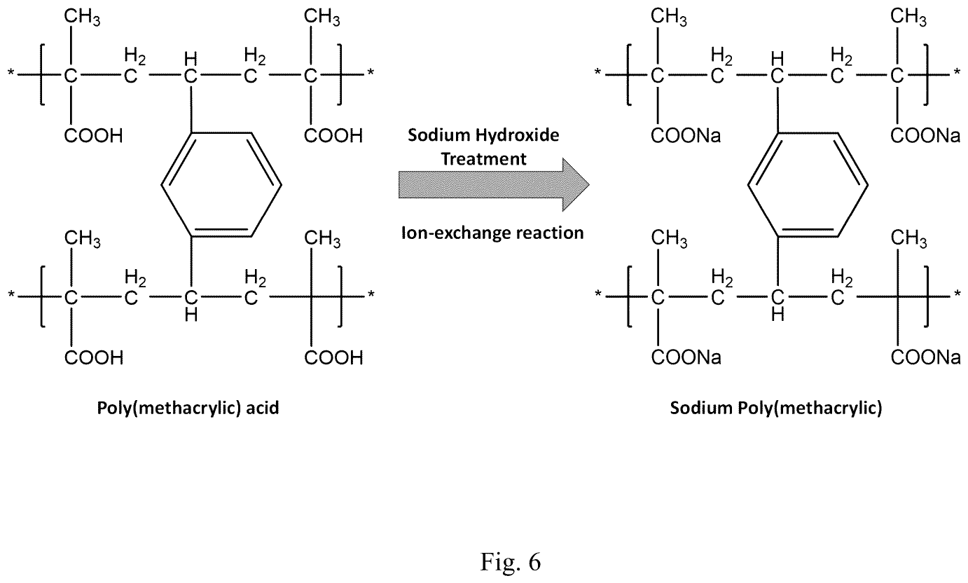

Sodium poly(methacrylic) was prepared by the addition of the poly(methacrylic) acid beads to 0.1 M sodium hydroxide for 1 hour, and then was washed with DI-water (FIG. 6).

### Characterization

Nitrogen isotherms were performed at 77° K using an ASAP2460 instrument. The specific surface area was calculated using Brunauer, Emmett, and Teller (BET). X-ray powder diffraction patterns of PMAA microspheres were conducted by a Bruker D8 X-ray diffractometer with Cu Kα radiation (λ=0.15406 nm). Samples were scanned from 5-80° (2θ value), 0.02° step, and 0.3 s per step.

FTIR-attenuated total reflection (ATR) analysis was performed using a PerkinElmer Spectrum 100 FT-IR spectrometer. The spectra were obtained from 400 to 4000 cm-1. SEM imaging was done by FEI Quanta 450 FEG scanning electron microscope (SEM).

Fluorescent imaging was done using an Olympus Fluorescent microscope. The PMAA microspheres were individually placed in the microscope with 1 mg/L fluorescein isothiocyanate isomer I (90%) dye.

### Mechanical Properties

The synthesized particles were tested for mechanical properties using Caldaro position sensors (Caldaro sadae, Japan) and Deben Microtest tensile stage. Deben Microtest software (V6.1.51) was used to process the data, and deformation resistance was calculated from the nominal stress and strain curve. The ramping velocity during this work was 0.2 mm/min. Nominal stress was calculated by dividing the force by the cross-sectional area of microspheres and a nominal strain by dividing displacement by the diameter of the particles before compression. The slope in the linear region of the stress-strain curve is used to evaluate the deformation resistance of elastic material. The analysis was repeated at least two times. The diameter of the particles was around 1 mm.

### Adsorption Experiments

A dialysate solution was prepared to closely mimic hemodialysis conditions to measure particles' efficiency in removing cations. The CitraPure solution was used to prepare the dialysate solution. The Citrapure was diluted 45 times. The concentration of the potassium was adjusted to 8.2 mmol/L. The sodium bicarbonate concentration was adjusted to 80 mmol/L. i-stat, a handheld blood analyzer, was used to measure Ph and electrolytes in porcine blood or dialysate. Chem 8+ and CG8+ were used as i-stat cartridges.

Adsorption tests were performed to explore the particles' adsorption efficiency and rate. The focus was on eliminating sodium, calcium, and potassium cations. For this purpose, 200 mg of particles were added into either 20 mL of dialysate solution or porcine blood, and the removal was measured using i-stat.

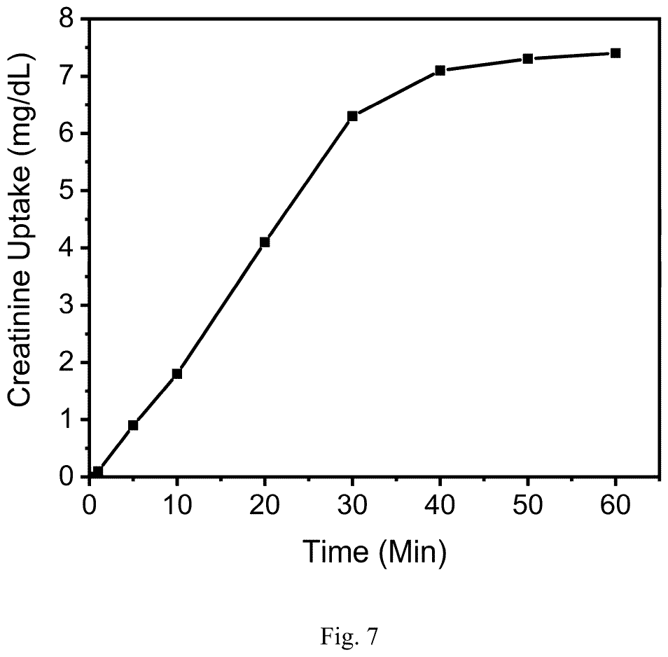

Alternatively, to evaluate the cation and creatinine removal rate of the particles, 200 mg of particles were added to 20 ml of dialysate solution for successful removal of creatinine by poly(methacrylic) acid beads in dialysate solution (FIG. 7).

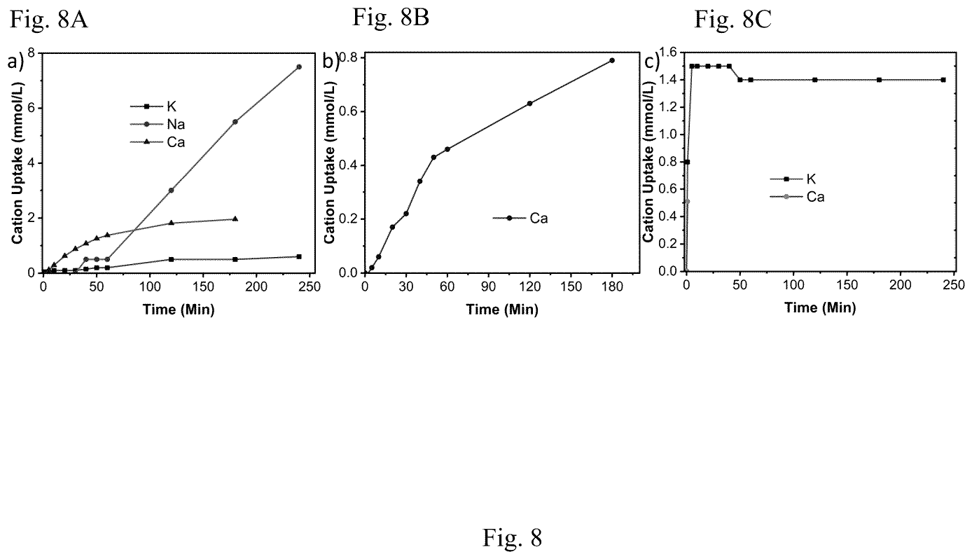

FIG. 8 shows the removal rate of the beads synthesized with 16% of the cross-linker in dialysate and porcine blood. However, cation removal is not limited to these cations.

Poly(methacrylic) acid beads can be used in hemodialysis and hemoperfusion methods to remove cations. The adsorption mechanism of the beads is based on ion exchange. Hydrogen atoms can be released and replaced by other cations, such as sodium. Alternatively, sodium or calcium-saturated beads can be used for hemodialysis and hemoperfusion.

### Blood Compatibility

Porcine whole blood was used for blood analysis, and it was provided by Lampire biological laboratories. 30 USP units/ml lithium heparin as an anticoagulant was added to the blood.

To investigate the biocompatibility of the PMAA particles, 200 mg of the particles were added to 20 mL porcine blood and incubated at 37° C. for 1 h. Then, the blood was collected, and 1 ml of blood per centrifuge tube was collected at room temperature and centrifuged for 15 mins at 12,000 rpm. The plasma layer separated from the blood was pipetted out from the top. The analyses were conducted on fresh plasma.

The anticoagulant properties were studied by measuring the clotting time. A prothrombin time using the i-stat PT/INR cartridge was used to evaluate the clotting time. The whole blood was used after blood incubation with PMAA-16 to measure PT/INR.

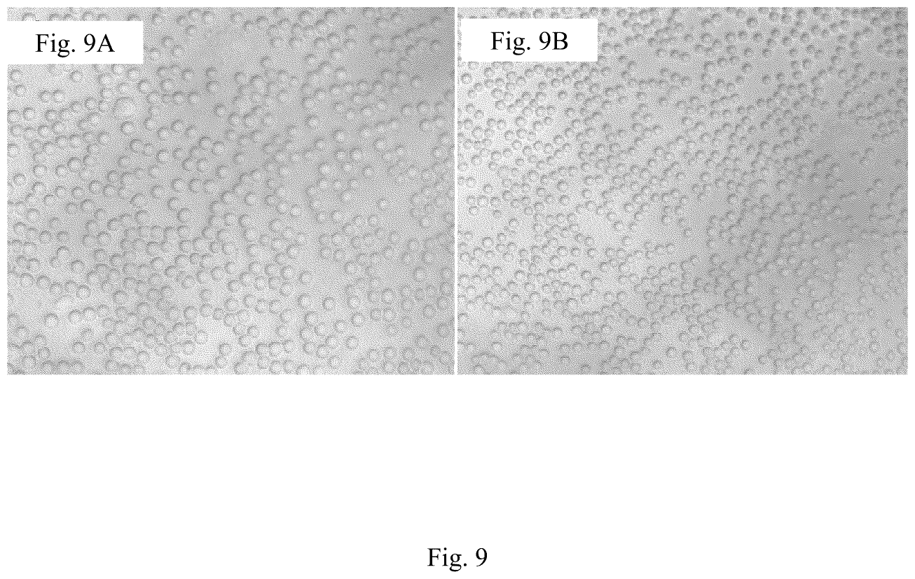

Alternatively, to investigate the blood compatibility of beads, the porcine blood was incubated with microbeads, and the clog time was measured. The morphology of the red blood cells was investigated using optical microscopic. The optical microscopic images in FIG. 9 show the morphologies of red blood cells (RBCs) sampled from the incubated porcine blood as control and blood incubated with the microbeads. The RBCs in these samples had a distinct outline with perfect circularity. The i-STAT PT/INR cartridge prothrombin time test investigated the anticoagulant properties. The prothrombin time of incubated porcine blood increased from 27.4 sec (INR 2.4) to 28.8 (INR 2.5) for the blood incubated with the microbeads.

Addition of polymeric beads and composites of polymers and nanomaterials in dialysate allows management of electrolytes and uremic toxins in dialysate, blood, and serum during hemodialysis. The addition of suspended particles leads to continuous flow of such particles in dialyzer (filtration unit) and dialysate flow; however, some suspended particles are intentionally added in dialysate solution with an intention to add stationary particles in the dialyzer. Thus, the removal and management of uremic toxins and electrolytes is achieved by the addition of moving and fixed particles that are initially added to the dialysate or dialyzer.

The results and discussion of the experiments performed herein will now be discussed.

The synthesis procedure for the PMAA particles is illustrated in FIG. 3. Microwave irradiation was used to synthesize organic and inorganic particles (Kempe et al., 2011, Macromolecules, 44, 5825; Sun et al., 2017, Nano Lett, 17, 1963). The direct interaction of microwave irradiation (microwave energy) with the molecules leads to rapid internal heating of the reaction mixture. In the synthesis, the reaction solution is gradually heated to the appropriate temperature, which relies on the strong absorption efficiency of microwave energy in monomer and crosslinker. The localized overheating can quickly initiate the reaction and formation of the particles.

### Scanning Electron Microscopy

Scanning Electron Microscopy (SEM) was employed to examine the morphology of PMAA (poly(methacrylic acid)) particles. The SEM images revealed that the particles were spherical, with no evidence of aggregation observed. The particles exhibited an average diameter of 0.75±0.26 mm for PMAA-3, 0.77±0.26 mm for PMAA-8, 0.81±0.28 mm for PMAA-16, and 0.73±0.20 mm for PMAA-25, respectively. Cracking observed in some PMAA-25 particles was believed to be related to drying. PMAA, as a hydrogel, undergoes shrinkage after drying. The increased concentration of divinylbenzene (DVB) in these particles leads to a decrease in the flexibility of the polymer chains, resulting in a more rigid and inflexible network structure. This shrinkage can cause internal stresses within the particles. The development of cracks in the PMAA-25 particles is a consequence of these stresses, which arise from the constrained and less adaptable nature of the densely crosslinked network.

### FTIR

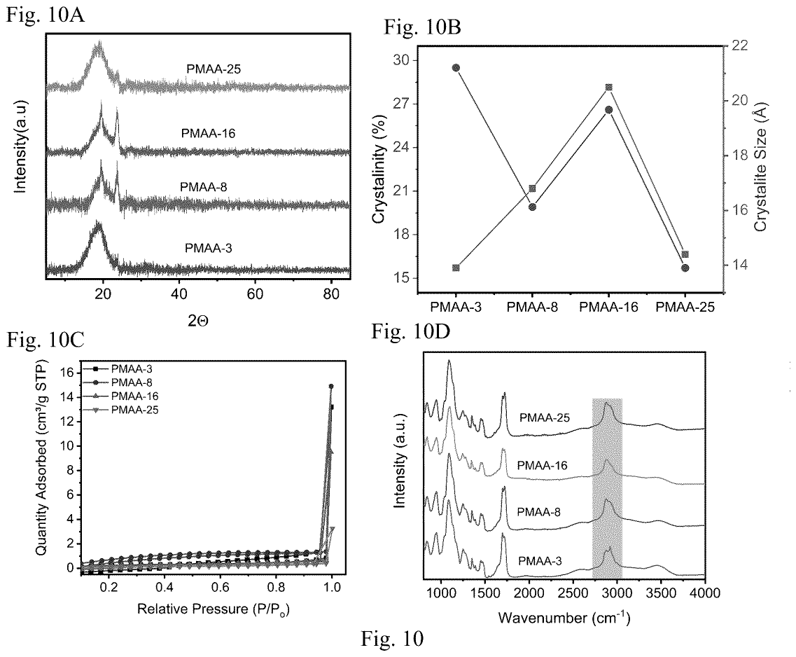

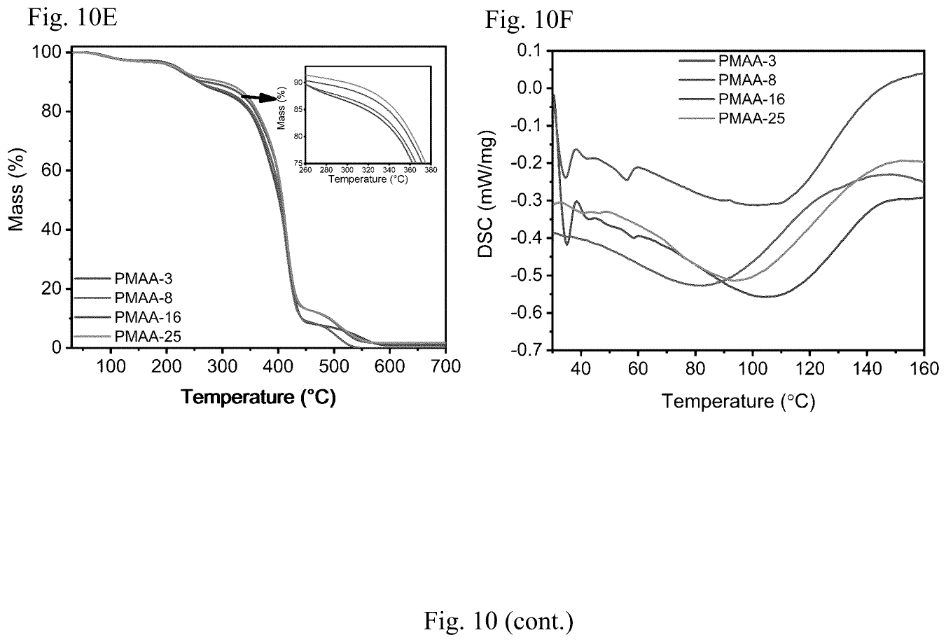

The chemical structure of PMAA (poly(methacrylic acid)) particles was analyzed using FTIR spectroscopy (FIG. 10). A peak at 1720 cm⁻¹ indicates the —OH stretching characteristic of carboxylic acids. The absorption band between 1690-1730 cm⁻¹ is ascribed to the carbonyl groups (C═O), a prominent characteristic feature of PMAA. Within this range, two peaks are attributed to variations in the molecular environment of the carbonyl groups within the polymer.

The C—H stretching band is evident in the 2800-3000 cm-1 range. A broad peak between 3200-3500 cm⁻¹ is associated with the stretching vibrations of hydroxyl groups in the polymer chains. Two noticeable peaks around 2870 cm-1 and 2916 cm-1 in the FTIR spectrum correspond to the stretching vibrations of alkyl groups. The peak at 2870 cm⁻¹ is linked to the stretching vibrations of the C—H bonds in PMAA, while the 2916 cm⁻¹ peak is related to the C—H bonds in the divinylbenzene's aromatic ring. Additionally, peaks at 1544 cm⁻¹ and 1402 cm⁻¹ are assigned to the asymmetrical stretching vibrations of the C═O and C—O—OH bending vibrations, respectively.

### DSC and TGA

The thermal behavior of the PMAA (poly(methacrylic acid)) particles was comprehensively investigated using Differential Scanning calorimetry (DSC) and Thermogravimetric Analysis (TGA). TGA revealed several stages in the thermal decomposition of the PMAA particles. The initial weight loss stage, occurring at about 70° C., is attributed to the loss of free water and the glass transition state of the particles. A minor weight loss (~6%) starting at 190° C. marks the beginning of the first degradation process, likely due to the degradation of lower molecular weight species. A significant decomposition is observed around 219° C., where approximately 80% weight loss indicates the major degradation phase, reducing the crosslinker percentage (Shim et al., 2004, Macromolecular Research, 12, 233). A third degradation phase is detected at about 440° C., characterized by the decomposition of methacrylic acid components and the more thermally stable crosslinked DVB (divinylbenzene) structure. The minimal residual mass at the end of the TGA run implies the complete thermal degradation of the particles.

The glass transition temperature of PMAA was not observed (Moulay, Mehadaoui, 2011, Journal of Applied Polymer Science, 100, 954). Being thermoset polymers, PMAA particles do not exhibit melting or crystallization peaks. A notable peak observed between 140-180° C. could be ascribed to the water loss of the particles.

### X-Ray Diffraction

The X-ray diffraction (XRD) pattern of PMAA (poly(methacrylic acid)) particles is illustrated in FIG. 10A. A broad peak observed for the PMAA particles indicates a high degree of disorder, characteristic of an amorphous structure within the samples. Crosslinking methacrylic acids with DVB (divinylbenzene) seems to prevent the formation of crystalline domains. Notably, increasing the concentration of the crosslinker (DVB) reveals an additional peak at 24°. However, increasing the concentration further to 25% diminishes the intensity of the peak at 24°.

As assessed by XRD, the crystallinity formation of the PMAA particles lies within a range of 15-30% (FIG. 10B). Utilizing the Scherrer equation, the crystallite size of the PMAA particles has been calculated to range between 14-22 Å. The formation of crystalline PMAA particles is attributed to the unique conditions facilitated by microwave synthesis.

### BET

A nitrogen adsorption-desorption experiment was conducted to evaluate the surface area, pore size, and pore diameter of PMAA (poly(methacrylic acid)) particles (FIG. 10C). The BET (Brunauer-Emmett-Teller) curve exhibits a sigmoidal shape, lacking a clear plateau at higher relative pressures, aligning with Type V behavior based on the International Union of Pure and Applied Chemistry (IUPAC) classification of nitrogen adsorption-desorption isotherms. This type of V isotherm, accompanied by H3 hysteresis loops, indicates a weak adsorbate-adsorbent interaction, typically observed in non-porous materials.

Essential parameters such as BET, Langmuir, surface area, total pore volume, and average pore diameter of the PMAA particles are detailed below. PMAA is a type of hydrogel that initially lacks porosity. However, porosity becomes evident after the hydrogel swells upon water addition. PMAA does not exhibit any porosity in its dry state, which explains why its Brunauer-Emmett-Teller (BET) surface area measurement is notably low.

| | | Total pore volume |
|---|---|---|
| | BET | of pores |
| PMAA-3 | 0.87 m²/g | 0.0180 cm³/g |
| PMAA-8 | 3.25 m²/g | 0.0216 cm³/g |
| PMAA-16 | 0.81 m²/g | 0.0143 cm³/g |
| PMAA-25 | 0.42 m²/g | 0.0006 cm³/g |

### Mechanical Properties of PMAA

Robust mechanical properties are crucial for the absorbents utilized in hemodialysis systems to prevent potential risks such as particle breakage, fragmentation, and subsequent release into the bloodstream. Therefore, PMAA (poly(methacrylic acid)) particles must uphold structural integrity throughout handling and application processes.

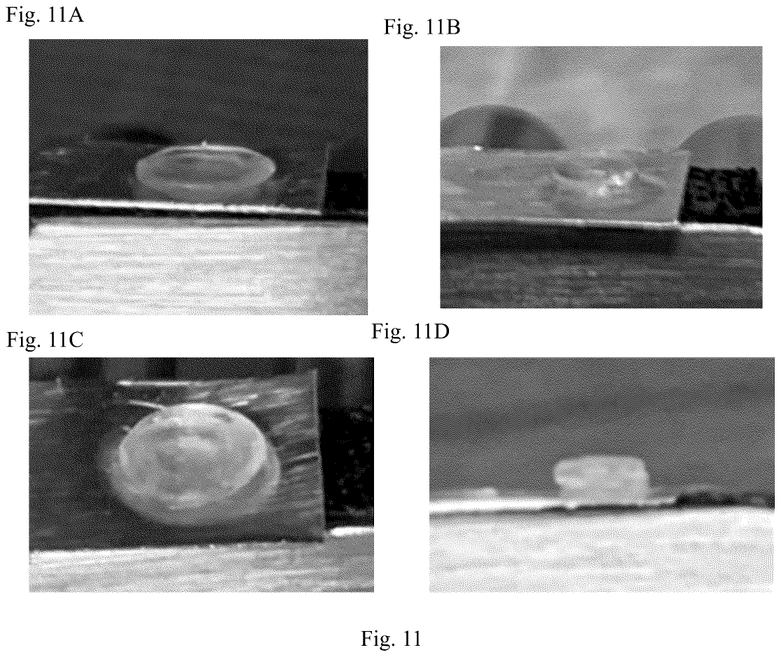

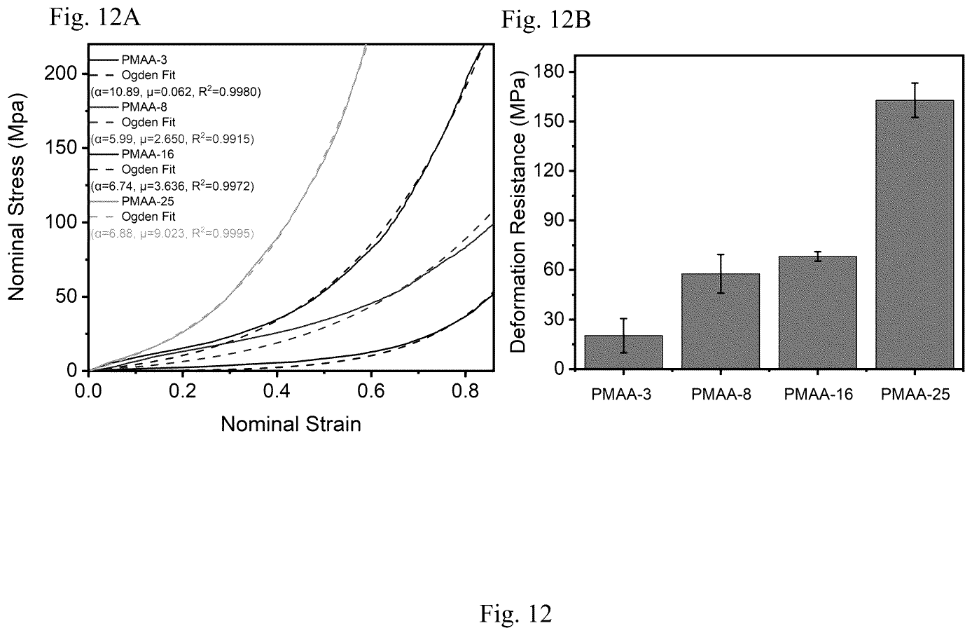

A single-particle compression test was conducted to assess the mechanical properties of PMAA particles, utilizing uniaxial compression to analyze the particles' elastic and plastic deformation behaviors. FIG. 11 shows the setup of the microspheres in the MicroTesting unit. The obtained force-displacement curves during compression are depicted in FIG. 12.

Upon exposure to compression forces, the PMAA particles experienced continuous shape modifications, enlarging the contact area. Consequently, nominal stress and nominal strain were employed as suitable parameters, computed by normalizing the force with the particles' cross-sectional area and the displacement with the particles' diameter, respectively.

PMAA particles demonstrated hyperelastic properties, a remarkable characteristic distinguishing them under mechanical stress. Unlike conventional elastic materials, hyperelastic substances can endure substantial deformations and revert to their initial configuration. The Ogden model, a nonlinear elastic framework, was employed for its aptness in analyzing materials exhibiting extensive strain behaviors, such as PMAA particles. The comparison between experimental data from PMAA particles and predictions by the Ogden model revealed a high degree of congruence. This strong correlation indicates the model's effectiveness in precisely representing the hyperelastic characteristics of PMAA particles. In the Ogden model, two essential parameters, alpha (α) and Mu (μ), are crucial for precisely characterizing the material's response to stress. The study determined that alpha (α) varied between 5.99 and 10.89, while Mu (μ) spanned a range of 0.062 to 9.023.

In the Ogden model, the parameter alpha (α) is pivotal for encapsulating the material's non-linear elasticity. It primarily affects the model's representation of changes in material stiffness under different strain levels. An alpha (α) range from 5.99 to 10.89 indicates a pronounced non-linearity in the stress-strain relationship of PMAA particles, implying a complex mechanical response to deformation. Mu (μ), indicative of the shear modulus, stands as a key parameter in the Ogden model. It dictates the initial gradient of the stress-strain curve, mirroring the material's resistance to shear or angular distortions. The escalation of Mu from 0.062 to 9.023 concurrent with rising divinylbenzene (DVB) concentrations signifies an increase in PMAA particles' stiffness with enhanced DVB content. This modulation in stiffness is vital for customizing the material's properties for particular uses, especially in applications where both elasticity and robustness are critical.

In a patent claim for a polymer characterized by specific Ogden model constants, the material, with alpha (α) values ranging from 5.99 to 10.89 and Mu (μ) spanning 0.062 to 9.023, demonstrates versatile application potential. For biomedical devices and implants, its high elasticity (alpha >5) and moderate stiffness (Mu 2-5) make it ideal for simulating biological tissues. In automotive and aerospace components, higher Mu values (6-9) ensure structural integrity and effective vibration damping. Electronics and robotics benefit from its lower Mu range (0.062 to 2), ensuring flexibility and deformability. For protective gear, a Mu range of 2-7 caters to varying impact resistance needs, while for seals and gaskets, higher Mu values (5-9) are advantageous for maintaining seal integrity under diverse conditions. In smart materials and actuators, the polymer's adaptability is highlighted by its wide Mu range, tailored to specific responsiveness requirements. Lastly, in sporting goods, a balanced Mu range (3-6) offers the necessary combination of durability and energy return, making the polymer suitable for a diverse array of applications where its unique mechanical properties can be effectively utilized.

Furthermore, deformation resistance was determined by calculating the slope within the linear region of the nominal stress-strain curve (FIG. 12B), providing valuable insights into the particles' mechanical robustness. In this study, the deformation resistance of the PMAA particles was determined by calculating the slope within the linear region of the stress-strain curve. The linear region of the curve represents the elastic behavior of the material, where deformation is reversible, and the material returns to its original shape after the removal of stress. The results from this analysis indicated that the rigidity of the PMAA particles increases with the concentration of the DVB (divinylbenzene) crosslinker. DVB crosslinks polymer chains and forms a particle morphology, enhancing the material's mechanical strength and stability. The increase in rigidity with higher DVB concentration suggests that more crosslinking leads to a stiffer and more robust particle structure.

This enhancement in stiffness is primarily due to the formation of chemical bonds between the polymer chains. These crosslinks create a network-like structure within the polymer, markedly reducing the mobility of the polymer chains. As a result, the PMAA becomes less flexible and more rigid because the interconnected chains are less able to move independently. This network structure also contributes to a uniform stress distribution throughout the material and increases its overall structural integrity. The enhanced stiffness and rigidity, reflected in the increased deformation resistance, are crucial for applications where durability and resistance to deformation under stress are key, such as in medical devices used in hemoperfusion.

### Cation Removal in Dialysate

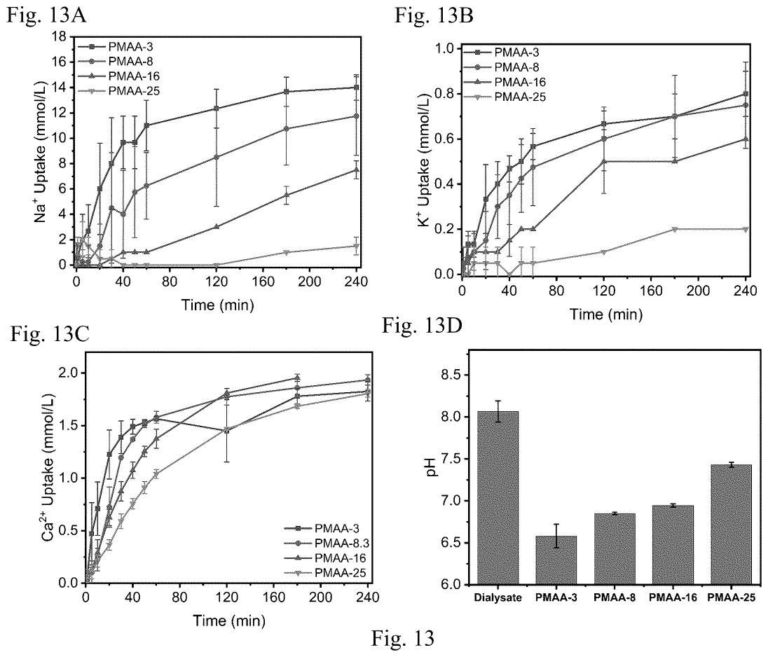

PMAA exhibits remarkable cation removal capacities, instrumental in water softening applications (Suteu et al., 2013, Journal of Applied Polymer Science, 131; Szlag, 1999, Clean Technologies and Environmental Policy, 1, 117). Cation removal by PMAA operates predominantly on a cation exchange mechanism. Functioning as a weak acid, PMAA showed affinity toward cations, resulting in the substitution of carbonyl group protons with cations. PMAA's efficacy in cation removal was evaluated by utilizing a dialysate solution with various cations to determine the PMAA particles' selectivity. FIG. 13 illustrates sodium, potassium, and calcium uptake levels in the dialysate solution throughout a typical 4-hour hemodialysis duration.

Metallic cations such as calcium and potassium were focal points, aiming to study the PMAA particles' adsorption kinetics and capacities. Introducing absorbent PMAA particles into the dialysate during hemodialysis indicates potential enhancements in the system's removal rates and capacities. Increasing the concentration of divinylbenzene (DVB) as a crosslinker in polymethacrylic acid (PMAA) particles leads to a decrease in the ion removal rate due to the polymer's structure and properties. A higher DVB content results in a more densely crosslinked network, limiting the number of available ion adsorption sites. Additionally, this denser network structure restricts the swelling capacity of the particles, restricting the ions' ability to penetrate and access internal binding sites. The increased crosslinking also causes reduced flexibility of the polymer chains, hindering the movement necessary for ions to reach functional groups within the polymer matrix. Furthermore, the altered chemical environment due to increased crosslinking may change the polymer's affinity for certain ions, further contributing to the reduced ion removal rate. These combined effects of enhanced crosslinking density significantly impact the efficiency of PMAA particles in ion removal applications.

The use of adsorbents in hemodialysis plays a crucial role, particularly in cleansing dialysate for its reuse. By incorporating PMAA particles into the dialyzer membrane or positioning them on the dialysate side, these particles aid in removing toxins through diffusion and adsorption (Ma et al., 2021, Microporous and Mesoporous Materials, 319). Furthermore, in the REDY (Regenerate Dialysis System) machine, a specialized filter system is utilized to clean the dialysate, decreasing the necessary volume from 120-200 liters to around six liters (Wong, 2009; Ash, 1986; Roberts, 2007, Nephrology, 4, 275; Ash, 2009, Seminars in Dialysis, 22, 615). The potential integration of Poly(methacrylic acid) (PMAA) adsorbents promises further advancements, particularly beneficial for portable and home-use hemodialysis equipment. The REDY machine is distinguished in the field of hemodialysis for its ability to regenerate and recycle dialysate efficiently. It uses a unique sorbent cartridge filled with materials such as activated carbon and ion exchange resins to eliminate impurities and excess ions from the used dialysate. This innovative approach allows the REDY system to operate with significantly less dialysate than traditional dialysis machines, enhancing its efficiency and environmental friendliness. It is especially suitable for situations with limited water resources and home dialysis settings, where space and resource efficiency are crucial.

The increase in pH observed with increasing concentrations of divinylbenzene (DVB) in polymethacrylic acid (PMAA) systems can be attributed to the reduced accessibility and reactivity of the acidic groups in the polymer. As DVB concentration increases, it creates a more densely crosslinked network within the PMAA structure. This denser network limits the exposure and accessibility of the carboxylic acid groups in PMAA to the surrounding medium, thereby reducing their ability to release hydrogen ions (H⁺) into the solution. Additionally, the increased crosslinking affects the polymer's swelling behavior and ion exchange properties, further diminishing the dissociation of acidic groups and leading to a decreased concentration of H⁺ ions in the solution. Consequently, this increases pH, as fewer free hydrogen ions are available to contribute to the solution's acidity.

Utilizing Poly(methacrylic acid) (PMAA) as an adsorbent in dialyzers presents a promising enhancement in hemodialysis efficiency and effectiveness. PMAA's intrinsic property of metal ion adsorption can be leveraged to increase the removal rate of waste products and excess ions from the blood. By integrating PMAA particles into the dialyzer, there is a potential to enhance the cation exchange capacity, hence promoting a more expedited purification process.

This enhancement in the purification rate could revolutionize the hemodialysis process by reducing the duration required for each session. A quicker hemodialysis process would be less inconvenient for patients and improve the overall patient experience and adherence to treatment schedules. Furthermore, a more efficient approach could also be beneficial from a resource and economic standpoint, as it might optimize the utilization of medical facilities and personnel.

### Cation Removal in Blood

PMAA particles have been evaluated for their potential application in hemoperfusion systems, particularly their ability to remove cations from porcine blood. The removal of potassium, sodium, and calcium ions was studied after introducing PMAA particles into the blood.

Despite the observed decrease in these ion concentrations in the dialysate, the potassium and sodium levels in the porcine blood did not show significant changes from the baseline levels following treatment with PMAA particles. This observation suggests that while PMAA particles can bind to and remove potassium and sodium ions, the overall concentration of these ions in the blood remains relatively stable. This stability could be due to several factors, including the dynamic equilibrium between the ions in the blood and those adsorbed on the particles, or the limited capacity of the particles to alter the total ion concentration in the blood significantly.

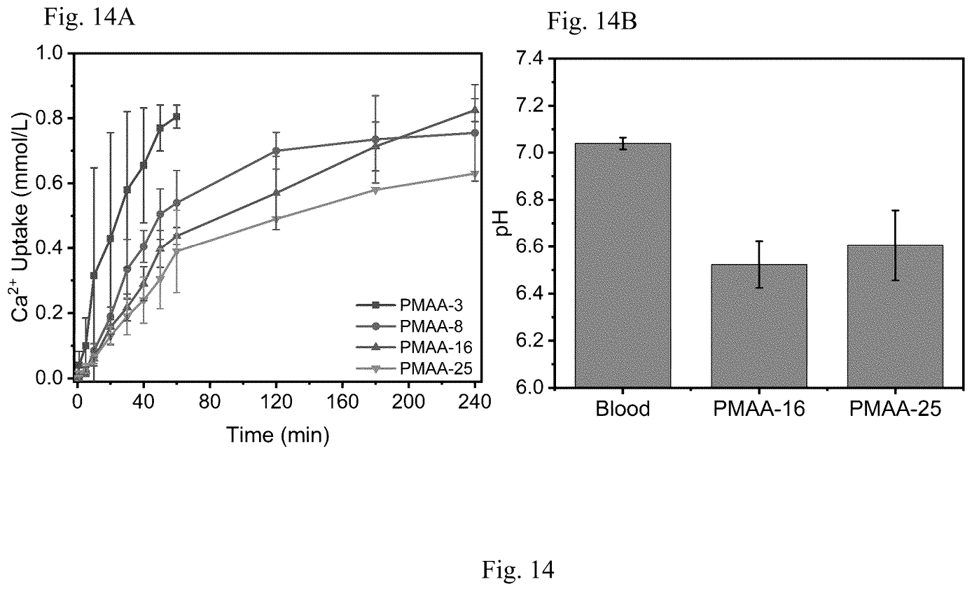

On the other hand, calcium ions were successfully removed (FIG. 14). Removing calcium ions correlated with pH levels, where a decrease in pH was observed proportional to the amount of calcium cations removed from the dialysate. Specifically, using PMAA-3 resulted in a blood pH below 6.5, which fell beneath the detection level of the i-stat device. The pH was 6.5 and 6.6 for the dialysate treated with PMAA-16 and PMAA-25, respectively.

PMAA-16 exhibited median performance regarding compatibility with blood and its overall suitability as a dialysate adsorbent, demonstrating it as a viable candidate for further analysis and study.

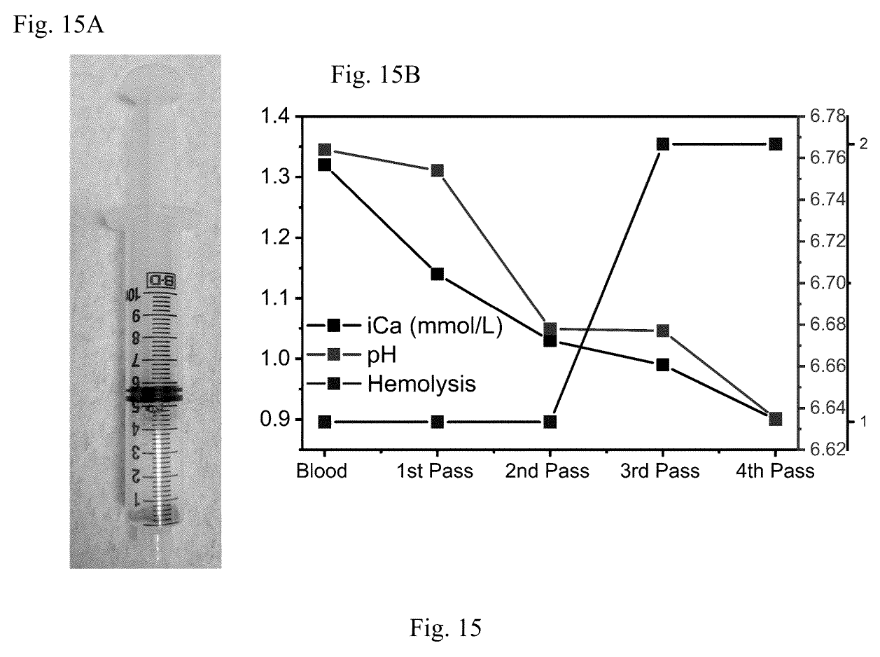

For a more detailed assessment of calcium removal in the hemoperfusion system, PMAA-16 particles were incorporated into a syringe through which 50 ml of porcine blood was circulated, as depicted in FIG. 15. The process involved multiple blood passes through the PMAA particles, after which calcium ion removal was measured. No apparent signs of hemolysis were attributed to the rupture of red blood cells and subsequent hemoglobin release after two passes. A marginal degree of hemolysis was observed post the second pass, coupled with a slight reduction in pH. This decrease in pH is attributable to the carboxylic groups of the particles interacting with the calcium ions, resulting in a replacement of Ca ions by hydrogen ions and a consequent subtle decrease in blood pH.

### Blood Compatibility

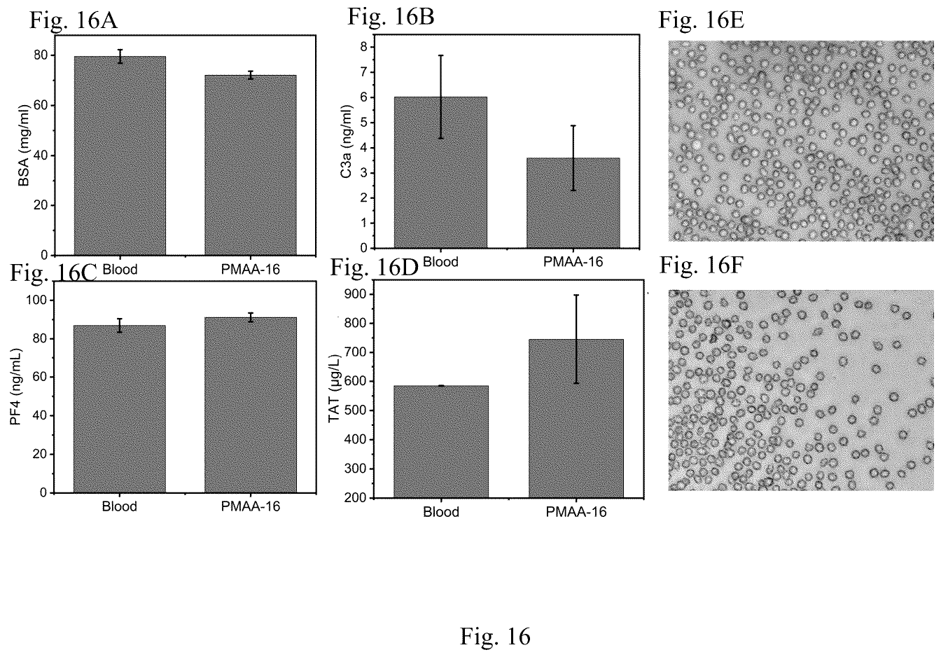

The selection of PMAA-16 for further analysis and study in blood compatibility tests is based on its promising performance in preliminary batch experiments (FIG. 16). In these initial tests, PMAA-16 showcased remarkable efficiency and viability as an adsorbent, establishing it as a candidate worthy of more in-depth evaluation.

In the hemoperfusion process, protein fouling is a significant concern as it can compromise the performance of the adsorbent particles. This occurs when proteins, such as Bovine Serum Albumin (BSA), adhere to the surface of the particles, forming a layer that impedes water permeability and increases the likelihood of cell adhesion, thus elevating the risk of thrombosis.

The BSA test was employed in the present study to assess the extent of protein adsorption on the particles. This test is designed to measure the amount of BSA protein that adheres to the particles, thus directly indicating the likelihood and severity of protein fouling. The results of the study, as illustrated in FIG. 16A, indicated a notably minimal adsorption of BSA protein by the PMAA-16 particles. This reduced tendency for protein adsorption not only enhances the efficiency of the hemoperfusion process but also potentially decreases the risk of thrombosis associated with cell adhesion, thereby improving the overall safety and effectiveness of the treatment.

Thrombin-antithrombin (TAT), Platelet Factor 4 (PF4), and C3a are essential biomarkers in blood compatibility tests and various medical studies. They offer critical information about the body's physiological processes, particularly in areas like hemostasis, inflammation, and immune response. Hemostasis refers to the process that prevents and stops bleeding or hemorrhage. It involves a complex sequence of events that lead to blood clotting. TAT is a key marker in this process, indicating the activity of thrombin, a crucial enzyme in blood clotting, and its inhibition by antithrombin, which is necessary to prevent excessive clot formation.

PF4, another vital biomarker, is associated with platelet activation and aggregation. It plays a significant role in wound healing and thrombosis. Elevated levels of PF4 can indicate heightened platelet activity, which is crucial in understanding thrombotic disorders.

C3a, on the other hand, is involved in the immune response, particularly in the activation of the complement system. The complement system is a part of the immune system that enhances (complements) the ability of antibodies and phagocytic cells to clear microbes and damaged cells, promote inflammation, and attack the pathogen's cell membrane. C3a is a fragment produced during the activation of the complement component C3, serving as a marker for the activation of the complement system.

In assessing the biocompatibility of PMAA particles, the study focused on the measurement of C3a concentration. This measurement is crucial as it indicates whether the PMAA particles activate the complement system, which could lead to adverse immune responses. The findings showed that the concentration of C3a in the presence of PMAA particles did not show significant deviation compared to untreated whole blood, as illustrated in FIG. 16B. This result suggests that the PMAA particles do not significantly activate the complement system. This lack of activation is a positive indicator of the biocompatibility of PMAA particles, as it implies a lower risk of inducing unwanted immune responses when used in medical applications, such as hemoperfusion.

The results, as detailed in FIG. 16C and FIG. 16D, revealed a nuanced response of blood components to PMAA particles. A slight increase in TAT concentration was observed after adding PMAA-16 particles. An increase in TAT levels can indicate a slight increase in thrombin activity.

The levels of PF4 did not exhibit any significant alteration upon exposure to PMAA-16 particles. PF4 is released by activated platelets and is a key factor in platelet aggregation and thrombus formation. Its stable concentration suggests that the PMAA-16 particles did not induce substantial platelet activation. This stability in PF4 levels is a positive indicator, as excessive platelet activation could lead to thrombotic complications.

These findings offer a comprehensive understanding of how PMAA particles interact with key components of the hemostatic system. The slight increase in TAT levels suggests a very mild procoagulant activity, while the stability of PF4 levels indicates a low risk of inducing excessive platelet activation. Together, these results contribute to the overall assessment of the biocompatibility of PMAA particles, highlighting their potential suitability for medical applications where blood-material interactions are critical, such as in hemoperfusion devices.

The optical microscopy images, as presented in FIG. 16E and FIG. 16F, offer a visual representation of the morphology of red blood cells (RBCs) before and after their incubation with PMAA-16 particles. These images are crucial for assessing the biocompatibility of the PMAA particles with blood. Notably, the RBCs maintained their characteristic circularity post-incubation, showing no signs of rupture or abnormal morphological changes. This preservation of the RBCs' integrity and shape is an important indicator of the blood compatibility of the PMAA-16 particles. The absence of any observable damage or alteration in the RBCs suggests that the PMAA-16 particles do not adversely affect the red blood cells, indicating their potential suitability for applications involving direct contact with blood, such as in hemoperfusion systems. This compatibility is essential to ensure that the particles do not induce hemolysis or other detrimental effects on the blood cells during their application.

Prothrombin time (PT) and the International Normalized Ratio (INR) were also assessed to gauge the impact of PMAA on coagulation status. Typically, the adult blood PT ranges between 8-14 seconds, and the INR falls between 0.7-1.2, barring the influence of blood-thinning medications. Analysis utilized porcine blood treated with lithium heparin, a common anticoagulant used in clinical chemistry analyses. The presence of heparin, as anticipated, resulted in elevated PT/INR values. Specifically, untreated whole blood exhibited a PT of 27.4 seconds (INR of 2.4), compared to 28.8 seconds (INR of 2.5) for blood interacting with PMAA-16.

Summarily, no significant alteration in the PT/INR values of porcine blood was detected after treatment with PMAA-16 particles, endorsing PMAA-16's compatibility for blood purification. Conversely, the PT was undetectable for blood treated with PMA-Na, suggesting its limited suitability as an adsorbent in hemoperfusion applications.

For future direction, the mixed absorbent beads, consisting of both ionic and cationic components, can be employed to control the pH. The anionic component releases hydrogen ions, while the cationic component releases hydroxyl ions. These counter ions interact, resulting in no change in pH.

A comprehensive exploration into the biocompatibility and effectiveness of PMAA particles under varying conditions should be investigated in future experiments. The influence of PMAA particle size on cation removal efficiency and kinetics can be explored in future studies. Additionally, an in-depth biocompatibility analysis, encompassing assessments such as cytotoxicity and impact on various blood components like white blood cells and platelets, is essential. To examine the adsorption capacities of PMAA particles towards a broader spectrum of ions, small molecules, or contaminants prevalent in the blood and their selectivity, elucidating the comprehensive applicability of PMAA particles in hemodialysis.

In this study, PMAA particles were successfully synthesized using microwave irradiation, manipulating the ratios of monomer and crosslinker to optimize their efficacy in cation removal applications such as hemodialysis and hemoperfusion. It was found that a rise in the crosslinker concentration led to a decrease in the efficiency of cation removal by PMAA particles. PMAA-16 demonstrated notable proficiency in cation removal while maintaining a stable pH level in porcine blood, emerging as a promising candidate for further studies and applications. The findings reveal that PMAA particles possess robust potential as effective adsorbents for cation removal in medical applications such as hemodialysis and hemoperfusion, displaying commendable compatibility with blood. In addition, the microwave-assisted synthesis approach utilized in this study unveils vast possibilities for synthesizing polymer particles using various monomers, broadening the horizons for diverse applications. Beyond medical applications like hemodialysis and hemoperfusion, the potential of PMAA particles extends to other crucial areas, such as wastewater treatment.

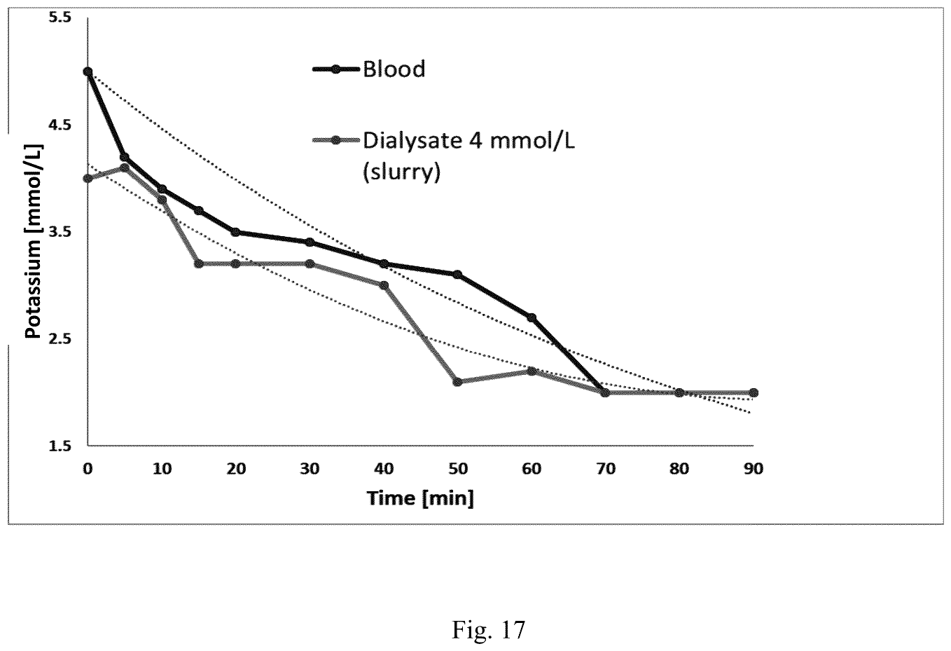

One of the most significant contributions of the proposed approach is the management of concentration gradients between the dialysate and blood throughout the treatment. In one of the proposed approaches, the concentration gradient between dialysate and blood is decreased and maintained at the lowest concentration gradient throughout the treatment (FIG. 17). This approach was specifically designed for management of potassium removal to minimize the possibility of cardiac events. The dotted lines represent theoretical concentration of potassium in blood and dialysate. The red and orange lines represent the experimental data collected using polymeric beads for the management of potassium during hemodialysis.

After synthesizing the beads, the particles can be embedded in a matrix or their surfaces can be modifies with specific ligands or coatings to enhance their biocompatibility or adsorption selectivity for target substances. The choice of surface modification chemistry depends on the target substances. The possible chemicals and ligands for surface modification are affinity ligands, polymeric coatings, chelating agents and silane coupling agents.

What is claimed is:

1. A method of synthesizing polyacrylic beads, comprising the steps of:
suspending a monomer and a cross-linking agent in a solution;
heating the solution in a microwave reactor;
cooling the solution; and
collecting the polyacrylic beads.

2. The method of claim 1, wherein the solution further comprises at least one additional component selected from the group consisting of hydroxyethyl cellulose, sodium chloride, and polyethylene glycol.

3. The method of claim 1, wherein the monomer is selected from the group consisting of methacrylic acid, dimethylaminomethyl methacrylate, butyl acrylate, ethyl acrylate, 2-hydroxyethyl methacrylate, vinyl acetate, 2-acrylamido-2-methylpropanesulfonic acid, vinylsulfonic acid, styrenesulfonic acid, 2-(dimethylamino)ethyl methacrylate, 2-(methacryloyloxy)ethyltrimethylammonium chloride, vinylphosphonic acid, 2-methacryloyloxyethylphosphonic acid, 2-hydroxyethyl methacrylate, vinyl pyrrolidone, ethylene glycol methacrylate, 2-methacryloyloxyethyl phosphorylcholine, allyl methacrylate, acrylic acid, methyl methacrylate, acrylate, glycidyl methacrylate, methacrylate derivatives of heparin, polyurethane with phosphorylcholine groups, silicone monomers, and combinations thereof.

4. The method of claim 1, wherein the cross-linking agent is selected from the group consisting of divinylbenzene, 2,2-bis(allyloxymethyl)-1-butanol, triallylamine, 7-octadiyne, 5-hexynoic acid, trimethylolpropane diallyl ether, diallyl ether, 1,3,5-triallyl-1,3,5-triazine-2,4,6(1H,3H,5H)-trione, ethylene glycol dimethacrylate, 1,4-butanediol dimethacrylate, tetraethylene glycol dimethacrylate, N,N′-methylenebis(acrylamide), 1,3-dioxolane-2,4-dione, N,N′-divinylurea, 1,7-octadiyne, hexamethylene diisocyanate, diallyl phthalate, cyanuric chloride, trimethylolpropane trimethacrylate, and combinations thereof.

5. The method of claim 1, wherein the reaction initiator is selected from the group consisting of benzoyl peroxide, azobisisobutyronitrile, potassium persulfate, and combinations thereof.

6. The method of claim 1, wherein the solution is heated in a microwave reactor for about 10 minutes.

7. The method of claim 1, wherein the solution is heated in a microwave reactor for about 30 minutes.

8. The method of claim 1, wherein the solution is heated in a microwave reactor for about 60 minutes.

9. The method of claim 1, further comprising the step of adding the polyacrylic beads to a sodium hydroxide solution to synthesize sodium polyacrylic beads.

10. The method of claim 9, wherein the sodium hydroxide solution has a concentration of about 0.1 M to about 0.2 M.

11. Polyacrylic beads synthesized using the method of claim 1.

12. The polyacrylic beads of claim 11, wherein the polyacrylic beads are hyperelastic.

13. The polyacrylic beads of claim 11, wherein the polyacrylic beads have an α value of about 5 to about 11 in the Ogden model.

14. The polyacrylic beads of claim 11, wherein the polyacrylic beads have a μ value of about 0.01 to about 10.0 in the Ogden model.

15. A method of removing solutes from a solution comprising the steps of:
providing the polyacrylic beads of claim 11; and
suspending the beads in a solution comprising at least one solute.

16. The method of claim 15, wherein the solution is selected from the group consisting of blood, porcine blood, dialysate, serum, contaminated water, and combinations thereof.

17. The method of claim 15, wherein the solutes are selected from the group consisting of creatinine, sodium cation, potassium cation, calcium cation, and combinations thereof.

18. The method of claim 15, wherein the polyacrylic beads are about 50 nm to about 100 nm in size.

19. The method of claim 15, wherein the polyacrylic beads are about 50 μm to about 100 μm in size.
